(19) United States
(12) Patent Application Publication
(10) Pub. No.: US 2010/0262048 A1
(43) Pub. Date: Oct. 14, 2010

(54) PASSIVE EXERCISE MACHINE

(76) Inventors: Youichi Shinomiya, Ibaraki-shi (JP); Takahisa Ozawa, Katano-shi (JP); Takao Gotou, Hirakata-shi (JP); Kazuhiro Ochi, Osaka-shi (JP)

Correspondence Address: Cheng Law Group, PLLC, 1100 17th Street, N.W., Suite 503, Washington, DC, 20036, US

(21) Appl. No.: 12/739,597

(22) PCT Filed: Oct. 24, 2008
(86) PCT No.: PCT/JP2008/069311

§ 371 Date: Apr. 23, 2010

(30) Foreign Application Priority Data
Oct. 26, 2007 (JP) 2007-279681
Oct. 31, 2007 (JP) 2007-284253
Dec. 28, 2007 (JP) 2007-341342

(51) Int. Cl. A61H 1/00

(52) U.S. Cl. 601/35

(57) ABSTRACT

In a signal processor 18, a calculation unit 181 calculates a center point of a load applied to a left-footrest on the basis of partial loads detected by left foot load sensors 160 and 161, and calculates a center point of a load applied to a right-footrest on the basis of partial loads detected by right foot load sensors 170 and 171. A judgment unit 183 measures a deviation between each of the center points calculated by the calculation unit 181 and the center point indicated by ideal characteristic curve stored in a storage unit 182. The judgment unit 183 determines a normal exercise when the both deviations are less than a predetermined threshold (5% of a distance from an original point to the center point indicated by the ideal characteristic curve). The judgment unit 183 determines an abnormal exercise when at least one of the deviations is not less than the predetermined threshold. A control unit 180 counts the number of times the deviation is not less than the predetermined threshold. When the counted number of times is not less than a predetermined number during a predetermined time, the control unit 180 deactivates a drive device 50. Accordingly, an exerciser's muscle is trained effectively.

### TECHNICAL FIELD

The present invention directed to a passive exercise machine which induces muscle activity of an exerciser, without effort by the exerciser.

### BACKGROUND ART

In the past, there have been proposed various types of passive exercise machines, such as a standing position type passive exercise machine and a sitting position type passive exercise machine, which induce muscle activity of an exerciser (user) without effort. The sitting position type passive exercise machine includes a left-footrest for bearing a left foot of the exerciser and a right-footrest for bearing a right foot of the exerciser. The sitting position type passive exercise machine induces the muscle activity of the exerciser who takes a sitting posture with one's feet resting respectively on the left-footrest and the right-footrest. The standing position type passive exercise machine includes a left-footrest for bearing the left foot of the exerciser and a right-footrest for bearing the right foot of the exerciser. The standing position type passive exercise machine induces the muscle activity of the exerciser who takes a standing posture with one's feet resting respectively on the left-footrest and the right-footrest.

For example, JP 2007-89650 discloses, as the existing sitting position type passive exercise machine, an exercise assisting device which include a left-footrest for bearing the left foot of the exerciser, a right-footrest for bearing the right foot of the exerciser, a seat for bearing buttocks of the exerciser, and a drive device for oscillating the seat. In the exercise assisting device of JP 2007-89650, the drive device oscillates the seat to vary a load applied respectively to the exerciser's feet by one's weight, thereby exercising the exerciser.

A movement of the seat is a composite movement with regard to a back-and-forth direction and a lateral direction. While the seat moves left from an initial position, the seat moves forward. At this time, the seat lowers a front end relative to a rear end thereof. That is, the seat moves forward and leftward with lowering the front end relative to the rear end. After that, the seat returns to the initial position, and subsequently moves right from the initial position while moving forward. That is, the seat lowers the front end relative to the rear end. After that, the seat returns to the initial position. The exercise assisting device repeats these movements to vary the load applied respectively to the exerciser's feet by one's weight, thereby exercising the exerciser.

However, the existing passive exercise machine has no ability to judge whether or not the exerciser uses the passive exercise machine properly. Therefore, even when the exerciser uses the passive exercise machine with an improper usage (such as an incorrect usage and an ineffective usage), the existing passive exercise machine can not judge that the exerciser does not use the passive exercise machine properly. As a result, the passive exercise machine fails to train muscles of the exerciser effectively.

### DISCLOSURE OF INVENTION

In view of above insufficiency, the purpose of the present invention is to provide a passive exercise machine capable of developing a muscle of an exerciser effectively.

The passive exercise machine in accordance with the present invention is adapted in use to induce muscle activity of an exerciser, and includes a left-footrest configured to bear a left foot of the exerciser, a right-footrest configured to bear a right foot of the exerciser, and a drive device configured to move a body of the exerciser to vary a load applied to the left-footrest by the left foot and a load applied to the right-footrest by the right foot. The passive exercise machine further includes a plurality of left foot load sensors, a plurality of right foot load sensors, and a calculation unit. The plurality of left foot load sensors is incorporated in different portions of the left-footrest to detect partial loads applied to the respective left foot load sensors. The different portions of the left-footrest are arranged in a longitudinal direction of the left-footrest. The plurality of right foot load sensors is incorporated in different portions of the right-footrest to detect partial loads applied to the respective right foot load sensors. The different portions of the right-footrest are arranged in a longitudinal direction of the right-footrest. The calculation unit is configured to calculate a center point of the load applied to the left-footrest on the basis of the partial loads detected by the left foot load sensors and a center point of the load applied to the right-footrest on the basis of the partial loads detected by the right foot load sensors. Moreover, the passive exercise machine includes a storage unit, a judgment unit, and a control unit. The storage unit is configured to store an ideal characteristic curve indicative of ideal time variation of both the center point of the load applied to the left-footrest and the center point of the load applied to the right-footrest. The judgment unit is configured to judge at regular intervals whether or not a deviation between each of the center points calculated by the calculation unit and the center point indicated by the ideal characteristic curve is not less than a predetermined threshold. The control unit is configured to count the number of times the deviation is not less than the predetermined threshold. The control unit is configured to, when the counted number of times is not less than a predetermined number during a predetermined time longer than the regular interval, control the drive device to decrease a speed at which the drive device moves the body of the exerciser.

According to this configuration, the passive exercise machine is capable of judging that the center point is moved forward when the feet resting respectively on the left-footrest and the right-footrest move forward, and judging that the center point is moved rearward when the feet resting respectively on the left-footrest and the right-footrest move rearward. Therefore, the passive exercise machine is capable of training the muscle of the exerciser effectively.

Preferably, the control unit is configured to, when the counted number of times is not less than the predetermined number during the predetermined time, control the drive device to decrease the speed gradually, and finally to stop moving the body of the exerciser.

According to this configuration, the passive exercise machine controls the drive device to decrease the speed. Therefore, the passive exercise machine is capable of instructing the exerciser who is not suitable for the passive exercise machine to stop using it.

Preferably, the passive exercise machine includes a seat which bears buttocks of the exerciser with one's feet resting respectively on the left-footrest and the right-footrest on its bearing surface. The drive device is configured to move the seat from an initial position in order to vary the center point of the load applied to the left-footrest and the center point of the load applied to the right-footrest.

According to this configuration, the passive exercise machine which the exerciser uses in the sitting posture can train the muscle of the exerciser effectively.

Alternatively, the drive device is configured to alternately repeat a mode of moving the left-footrest forward and raising the front end relative to the rear end thereof, while moving the right-footrest to lower the front end relative to the rear end thereof, and another mode of moving the right-footrest forward and raising the front end relative to the rear end thereof, while moving the left-footrest to lower the front end relative to the rear end thereof.

According to this configuration, the passive exercise machine which the exerciser uses in the standing posture can train the muscle of the exerciser effectively.

Alternatively, the control unit is configured to count the number of times after controlling the drive device to decrease the speed, the control unit being configured to, when the counted number of times is kept less than the predetermined number for a certain period during the predetermined time, control the drive device to increase the speed.

According to this configuration, in anticipation of that exerciser might not use the passive exercise machine properly for reason of that the speed is too fast, the passive exercise machine can move the exerciser initially at a low speed, and increase the speed after the exerciser gets used to the passive exercise machine.

Alternatively, the drive device is configured to move the left-footrest and the light-footrest respectively. The judgment unit is configured to judge whether or not the exerciser is in a predetermined exercise position, on the basis of the partial loads detected by each of the left foot load sensors and each of the right foot load sensors. The control unit is configured to, when the judgment unit judges the exerciser is not in the exercise position while the drive device moves the left-footrest and the light-footrest respectively, control the drive device to stop moving the left-footrest and the right-footrest.

According to this configuration, the passive exercise machine stops moving the left-footrest and the right-footrest when the exerciser fails to be in the predetermined exercise position while moving the left-footrest and the right-footrest (while the passive exercise machine is in use). Therefore, the passive exercise machine can avoid the exerciser uses the passive exercise machine with an improper posture. The passive exercise machine prevents the exerciser from being injured, thereby improving its safety.

Preferably, the judgment unit is configured to calculate a projected weight center of the exerciser based on respective locations of the left foot load sensor and the right foot load sensor, as well as the partial loads respectively detected at the left foot load sensor and the right foot load sensor. The projected weight center is defined as a point to which the weight center of the exerciser projects vertically down on a horizontal plane in which the left foot load sensor and the right foot load sensor are arranged. The judgment unit is configured to judge that the exerciser is out of the predetermined exercise position when the projected weight center deviates from a prescribed range in the horizontal plane.

According to this configuration, the passive exercise machine can judge that the exerciser is out of the predetermined exercise position before the entire foot of the exerciser departs from the resting surface, by means of calculating the projected weight center of the exerciser. For example, before the exerciser loses a balance of an every part of the body, in short, when the exerciser loses a balance of the upper part of the body, the passive exercise machine can stop moving the left-footrest and the right-footrest. Therefore, the passive exercise machine improves its safety.

Alternatively, the passive exercise machine includes a seat, a footrest, a device, a seat position detection unit, and a determination unit. The seat is configured to swing with associated movements in back-and-forth direction, the seat being configured to bear buttocks of the exerciser. The footrest is configured to function as the left-footrest or the right-footrest. The footrest is configured to bear the foot of exerciser who sits on the seat. The footrest is configured to move downward while the exerciser presses down the footrest by one's foot and to return upward while the exerciser releases the footrest. The device is configured to function as the drive device. The device is configured to move the seat to its forwardmost position within a moving range to force the exerciser to make pressing down the footrest, thereby varying a load applied to a leg of exerciser by own weight. The seat position detection unit is configured to detect an event when the seat moves to its forwardmost position within the moving range. The determination unit is configured to judge that a knee angle of the exerciser is kept within a desired range when a necessary time is not more than a predetermined response time, and that the knee angle is out of the desired range when the necessary time is more than the predetermined response time. The necessary time starts from detection of the event and ends at a time when the left foot load sensor and the right foot load sensor detect the pressing down.

According to this configuration, the determination unit judges that the knee angle of the exerciser is kept within the desired range when the necessary time is not more than the predetermined response time, and that the knee angle is out of the desired range when the necessary time is more than the predetermined response time. The necessary time starts from detection of the event, and ends at the time when the left foot load sensor and the right foot load sensor detect the pressing down. Therefore, the determination unit can judge whether or not the knee angle of the exerciser is kept within the desired range. In short, while the exerciser makes a proper exercise where the knee angle is kept within the desired range, the load acting on the leg of the exerciser is increased as the seat moves forward. In this instance, the pressing down the footrest with the foot of the exerciser is detected within the response time from a time at which the seat has moved to the front most position. Accordingly, the determination unit determines that the knee angle of the exerciser is kept within the desired range. For example, in case when the exerciser fails to make the proper exercise with one's knee angle being kept within a desired range for reason of that the height position of the seat is not commensurate with the exerciser's physique or the exerciser is insufficient in pressing down the footrest, there arises a delay in pressing down the footrest sufficiently with the exerciser's foot. In this consequence, no detection of pressing down the footrest is made within the response time starting from a time when the seat moves to its front most position, whereby the determination unit determines that the knee angle of the exerciser is not kept within the desired range. Therefore, the passive exercise machine can instruct the exerciser to make the proper exercise where the knee angle of the exerciser is kept within the desired range, thereby being able to give a preferable exercise effect to the exerciser.

Preferably, the control unit is configured to, when the number of times the determination unit judges the knee angle is out of the predetermined range becomes equal to a predetermined number of times, control the drive device to slow down a movement of the seat gradually, and finally to stop the seat.

According to this configuration, the control unit controls the drive device to stop the seat when the exerciser fails to keep own knee angle within the desired range. Therefore, for example, the passive exercise machine can avoid that the exerciser suffering from knee pains is burdened continuously. Further, the control unit slows down and finally stops the seat. Accordingly, the passive exercise machine can avoid that the exerciser is dropped off the seat when the seat is stopped. The seat is kept moving until the number of times the determination unit judges that the knee angle of the exerciser is out of the desired range becomes equal to the predetermined number of times. Accordingly, even if the exerciser fails to press down the footrest only once while continuing to make the proper exercise with one's knee angle kept within the desired range, the passive exercise machine keeps the seat moving and allows the exerciser to continue making the proper exercise.

Preferably, the passive exercise machine comprises a report unit configured to report a result of the determination unit to the exerciser. The report unit includes at least one of a display unit displaying the result and an audio output unit producing a sound indicative of the result.

According to this configuration, the passive exercise machine is capable of notifying the exerciser of whether or not the knee angle of the exerciser is kept within the desired range. Therefore, the exerciser is motivated to exercise with one's knee angle kept within the desired range. The passive exercise machine can give a preferable exercise effect to the exerciser.

### BRIEF DESCRIPTION OF DRAWINGS

FIG. 1 is a block diagram illustrating a configuration of a passive exercise machine in accordance with 1st embodiment of the present invention,

FIG. 2 is a side view illustrating the above passive exercise machine,

FIG. 3 is a plane view illustrating the above passive exercise machine,

FIG. 4A is a diagram illustrating a characteristic curve of a center point of each footrest of the above passive exercise machine,

FIG. 4B is a diagram illustrating the characteristic curve of the center point of each footrest of the above passive exercise machine,

FIG. 5 is an exploded perspective view of the above passive exercise machine,

FIG. 6 is an exploded perspective view of a drive device employed in the above passive exercise machine,

FIG. 7 is a side view illustrating the above drive device,

FIG. 8 is a plane view illustrating the passive exercise machine in accordance with 2nd embodiment of the present invention,

FIG. 9 is an exploded perspective view of the above passive exercise machine,

FIG. 10 is a cross section view illustrating the above passive exercise machine from a back side,

FIG. 11A is an explanatory view illustrating an operation of a principle part of the above passive exercise machine,

FIG. 11B is an explanatory view illustrating the operation of the principle part of the above passive exercise machine,

FIG. 12 is a perspective view illustrating the principle part of the above passive exercise machine,

FIG. 13 is a block diagram illustrating a configuration of the above passive exercise machine,

FIG. 14 is a cross section view illustrating the above passive exercise machine from a right side,

FIG. 15 is an explanatory view illustrating a foot position while the above passive exercise machine is in use,

FIG. 16 is an explanatory view illustrating a position of a load sensor of the above passive exercise machine,

FIG. 17 is a graph illustrating one example of a time variation of the number of rotations of a motor employed in the above passive exercise machine,

FIG. 18A is a side view illustrating a passive exercise machine in accordance with 3rd embodiment of the present invention,

FIG. 18B is a plane view illustrating the above passive exercise machine,

FIG. 19 is a block diagram illustrating a configuration of the above passive exercise machine,

FIG. 20A is an explanatory view illustrating an operation of the above passive exercise machine,

FIG. 20B is an explanatory view illustrating the operation of the above passive exercise machine, and

FIG. 20C is an explanatory view illustrating the operation of the above passive exercise machine.

### BEST MODE FOR CARRYING OUT THE INVENTION

### 1st Embodiment

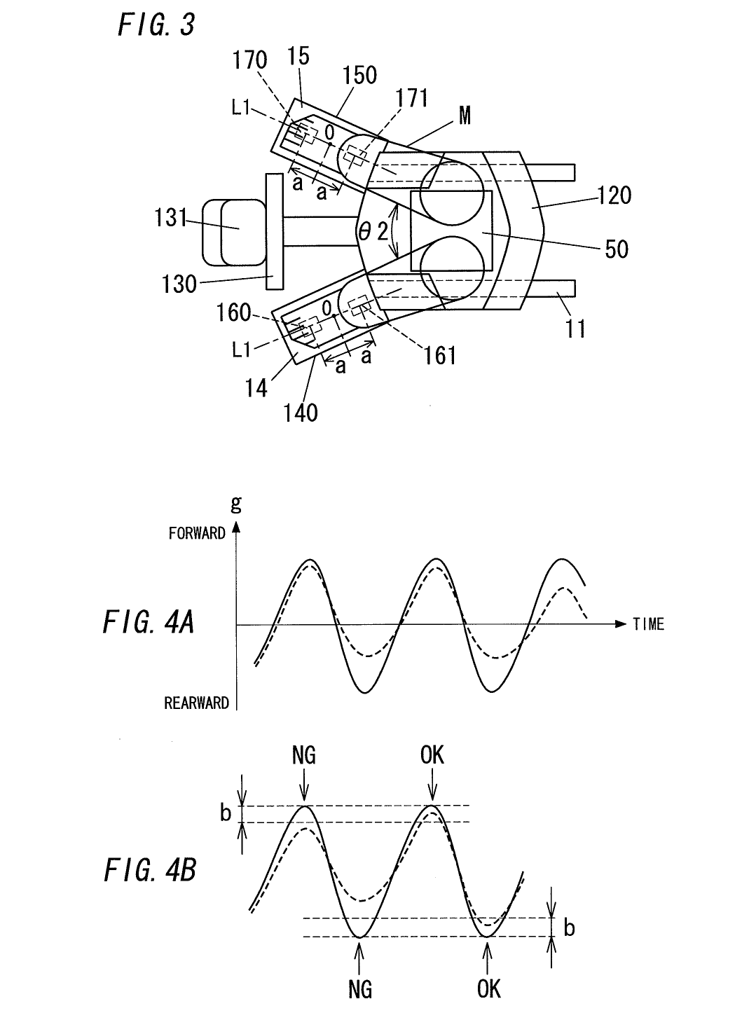

First, an explanation is made to a configuration of the passive exercise machine of the first embodiment. As shown in FIG. 2, the passive exercise machine of the present embodiment is a standing-position type passive exercise machine which induces muscle activity of the exerciser (user) M. The passive exercise machine includes a platform 11 located at a predetermined position (such as, an arbitrary position in a floor), a seat supporter 12 with a seat 120 which is configured to bear buttocks of the exerciser M, a handle post 13 with handles 130 which is adapted in use to be held with exerciser's hand, a left-footrest 14 with a foot resting surface 140 in its top surface, and a right-footrest 15 (see FIG. 3) having a foot resting surface 150 in its top surface. The seat supporter 12 is located on the platform 11.

The passive exercise machine is used in a manner such that exerciser M sits on the seat 120 with one's buttocks on a bearing surface 121 which is a top surface of the seat 120. That is, the exerciser M uses the passive exercise machine in a sitting-position. It is noted that the platform 11 may be embedded in the floor. In the following explanation, an upward direction and a downward direction are defined with reference to a situation where a platform 11 is disposed on the floor, and a back-and-forth direction and a lateral direction are defined with respect to the exerciser sitting on the seat 120. Accordingly, the leftward direction in FIG. 2 denotes the forward direction, and the upward direction of FIG. 3 denotes the rightward direction.

The left-footrest 14 and the right-footrest 15 are located on the platform 11 and between the seat supporter 12 and the handle post 13. Each of the foot resting surfaces 140 and 150 is formed to have such dimensions as to bear the entire foot (entire sole) of the exerciser M. The left-footrest 14 and the right-footrest 15 hold the feet a predetermined position while the exerciser M rests the feet on the foot resting surfaces 140 and 150 such that the soles are contacted to the foot resting surfaces 140 and 150 respectively. The foot resting surface 140 of the left-footrest 14 and the foot resting surface 150 of the right-footrest 15 are made of a material having a high friction coefficient or formed to have a shape having the high friction coefficient in order to prevent the foot rested on each of the left-footrest 14 and the right-footrest 15 from slipping on each of the foot resting surfaces 140 and 150.

As shown in FIG. 3, the left-footrest 14 includes two left foot load sensors 160 and 161 incorporated in different portions of the left-footrest 14 to detect partial loads applied to the respective left foot load sensors 160 and 161. Likewise, the right-footrest 15 includes two right foot load sensors 170 and 171 incorporated in different portions of the right-footrest 15 to detect partial loads applied to the respective right foot load sensors 170 and 171. The two left foot load sensors 160 and 161 (the different portions of the left-footrest 14) are arranged in a longitudinal direction of the left-footrest 14. The two right foot load sensors 170 and 171 (the different portions of the right-footrest 15) are arranged in a longitudinal direction of the right-footrest 15.

The seat supporter 12 shown in FIG. 2 is formed with the seat 120 at its upper end. In addition, the seat supporter 12 includes a drive device 50 configured to oscillate the seat 120, an up-and-down device 60 configured to move up and down the seat 120 and the drive device 50 relative to the platform 11, and a signal processor 18 configured to control the drive device 50.

The seat 120 is configured to bear buttocks of the exerciser M with one's feet resting respectively on the left-footrest 14 and the right-footrest 15 on its bearing surface 121.

The drive device 50 is configured to oscillate the seat 120 to move the buttocks of the exerciser M who is sitting on the bearing surface 121 of the seat 120 with one's feet resting respectively on the foot resting surface 140 of the left-footrest 14 and the foot resting surface 150 of the right-footrest 15, thereby varying a center point of the load applied to the left-footrest 14 and a center point of the load applied to the right-footrest 15. In this instance, the weight of the exerciser M is supported at three-points, namely, the seat 120, the left-footrest 14, and the right-footrest 15. Under the condition where the weight of the exerciser M is supported at distributed points of the buttocks and the legs, the drive device 50 moves the seat 120 in such a manner as to displace the buttocks of the exerciser M, thereby varying a proportion of bearing the exerciser's weight between the seat 120 and the footrests 14 and 15. In this consequence, the drive device 50 varies the exerciser's weight acting on the buttocks, thereby varying the weight acting on each of the feet of the exerciser M. Accordingly, the drive device 50 is responsible for varying the loads supported by the left-footrest 14 and the right-footrest 15.

Under the condition that an angle θ1 of a knee of the exerciser M is kept in a predetermined range, as the seat 120 moves toward its forwardmost position within a moving range, the load applied to the seat 120 by the weight of the exerciser M is decreased. In this instance, a load applied to a femoral region of the exerciser M is increased. This is similar to bending exerciser's own knee during a squat exercise. That is, an oscillation of the seat 120 between the forwardmost position and a rearwardmost position within the moving range induces a passive exercise not an active exercise of the exerciser M. Accordingly, a muscle of the femoral region repeats tonus and laxity.

Preferably, an oscillation direction of the seat 120 is selected such that a shearing force does not act on the knee joint. Under the condition that the seat 12 bears the buttocks of the exerciser M on its bearing surface 120, a posture of the exerciser M shown in FIG. 3 is a natural posture in which a distance between toes is greater than a distance between heels. A spread angle θ2 between the feet is determined by positions where the exerciser M rests one's feet on the left-footrest 14 and the right-footrest 15 respectively. The left-footrest 14 and the right-footrest 15 are not located in parallel, but located such that a distance between a center line L1 connecting a front end and a rear end of the foot resting surface 140 and a center line LA connecting a front end and a rear end of the foot resting surface 150 is greater toward the front end than at the rear end. That is, the exerciser M can take above mentioned natural posture by resting one's feet respectively on the foot resting surfaces 140 and 150 along the center line L1. The spread angle θ2 of the exerciser M taking the natural posture is nearly identical to an angle between the center line L1 of the foot resting surface 140 and the center line L1 of the foot resting surface 150.

The passive exercise machine can exercise the exercise M without acting the shearing force on the knee joint by means of oscillating the seat 120 along the center line L1 connecting the toe and the heel of each of the feet while the exerciser M rests one's feet respectively on the left-footrest 14 and the right-footrest 15. Namely, the passive exercise machine has a period in which the seat 120 moves forward and rightward as well as a period in which the seat 120 moves forward and leftward while the seat 120 moves from the rearwardmost position to the forwardmost position. While the seat 120 moves forward and rightward, the exerciser's weight acts on the femoral region of the exerciser's right leg. While the seat 120 moves forward and leftward, the exerciser's weight acts on the femoral region of the exerciser's left leg. Accordingly, the passive exercise machine can apply the load by the exerciser's own weight to the femoral region of the respective feet without acting the shearing force on the knee joint.

Preferably, the bearing surface 121 contacting to the buttocks of the exerciser M is formed to be inclined forward along the oscillation direction in order to easily change the exerciser's weight acting on the legs of the exerciser M with moving the seat 120. That is, a portion bearing the right buttock of the exerciser M in the front end portion of the seat 120 is inclined forward and rightward, and a portion bearing the left buttock of the exerciser M in the front end portion of the seat 120 is inclined forward and leftward. This construction can easily increase the exerciser's weight acting on the legs of the exerciser M when the seat 120 is moved from the rearwardmost position (initial position) to the forwardmost position within the moving range (oscillating range). Accordingly, the passive exercise machine can enhance an effect of exercise.

While the seat 120 is inclined forward and leftward, the load from the left foot of the exerciser M to the left-footrest 14 becomes greater toward the toe side (front side) than at the heel side. As a result, the center point of the load applied to the left-footrest 14 moves to the toe side. Thereafter, while the seat 120 is subsequently returning to the initial position, the load from the left foot of the exerciser M to the left-footrest 14 becomes greater toward the heel side (rear side) than at the toe side. As a result, the center point of the load applied to the left-footrest 14 moves to the heel side. On the other hand, while the seat 120 is inclined forward and rightward, the load from the right foot of the exerciser M to the right-footrest 15 becomes greater toward the toe side (front side) than at the heel side. As a result, the center point of the load applied to the right-footrest 15 moves to the toe side. While the seat 120 is subsequently returning to the initial position, the load from the right foot of the exerciser M to the right-footrest 15 becomes greater toward the heel side (rear side) than at the toe side. As a result, the center point of the load applied to the right-footrest 15 moves to the heel side.

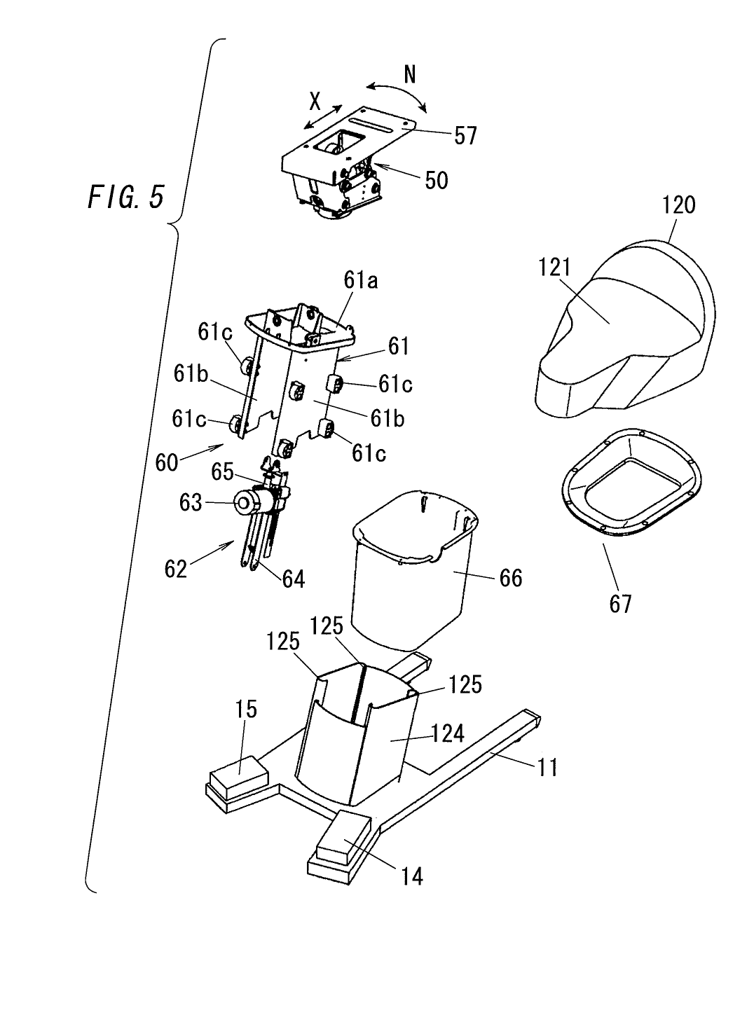

As shown in FIG. 5, a pole brace 124 is shaped into a tubular shape and is vertically arranged on the platform 11. The up-and-down device 60 is housed in the pole brace 124.

By the way, the passive exercise machine of the present embodiment requires keeping a knee angle of the exerciser at a proper angle in order to trigger muscle contraction of femoral muscles without causing any knee pain to the exerciser suffering from the knee pain. The exercise according to the passive exercise machine is similar to a squat exercise in which the exerciser's own weight is acting on the femoral region with one's knee kept at predetermined angle. In the exercise according to the passive exercise machine, the left and right feet are fixed by being rested respectively on the left-footrest 14 and the right-footrest 15 while the exerciser uses the passive exercise machine. Further, the knee joint and the ankle joint are preferred to be aligned along the vertical direction in order to increase the load acting on the femoral region. In consideration of these restrictions, the knee angle is determined by the position of the seat 120. However, a length of the feet depends on individuals, and especially varies greatly according to a height of the exerciser M.

As described in the above, the up-and-down device 60 is configured to vary a height position of the seat 120. The up-and-down device 60 includes an up-and-down base 61 configured to move up and down relative to the pole brace 124. The drive device 50 is mounted at an upper end of the up-and-down base 61.

The up-and-down base 61 includes a pedestal 61a on which the drive device 50 is mounted, a pair of guide plates 61b protruded downward from a lower surface of the pedestal 61a, rollers 61c provided on a exterior surface of each of the guide plates 61b. The roller 61c rolls along a rail 125 provided on an inner surface of the pole brace 124 while the guide plates 61b is inserted in the pole brace 124, thereby the up-and-down base 61 moving up and down along a central axis of the pole brace 124. The up-and-down base 61 is driven by an up-and-down drive unit 62 including a drive motor 63.

The up-and-down drive unit 62 includes an immobile member 64 fixed on the platform 11, and a mobile member 65 moving up and down along the central axis of the pole brace 124 relative to the immobile member 64 by a driving force of the drive motor 63. The up-and-down base 61 is provided at the upper end of the mobile member 65.

There is an up-and-down cover 66 being attached to the pedestal 61a in order to conceal the up-and-down device 60. The up-and-down cover 66 has a tubular shape enough to cover an exterior surface of the pole brace 124 within a range where the up-and-down drive unit 62 varies its length. Further, a gap between the pedestal 61a and the seat 120 is covered with a fabric cover 67 for concealing machineries.

The up-and-down device 60 is capable of moving up and down the bearing surface 121 of the seat 120 in order to suit a height of the bearing surface 121 to a physique of the exerciser M. In the present embodiment, the up-and-down device 60 adjusts automatically the height of the seat 120 such that the knee angle θ1 of the exerciser M is kept within a desired range when a parameter such as a height of the exerciser M is input by the use of a following operation unit 131. The central axis of the pole brace 124 which determines an up-and-down direction of the seat 120 is inclined relative to the vertical direction. Therefore, the seat 120 moves rearward while moving upward.

The up-and-down device 60 moves the seat 120 along a straight line tilted back relative to the platform 11, adjusting a position of the bearing surface 121 such that the bearing surface 121 of the seat 120 moves rearward while moving upward. The up-and-down device 60 adjusts the position of the bearing surface 121 of the seat 120 along each of the vertical direction and the back-and-forth direction such that the knee angle of the exerciser M becomes a desired angle while the exerciser M sits on the seat 120 with one's feet resting respectively on the left-footrest 14 and the right-footrest 15.

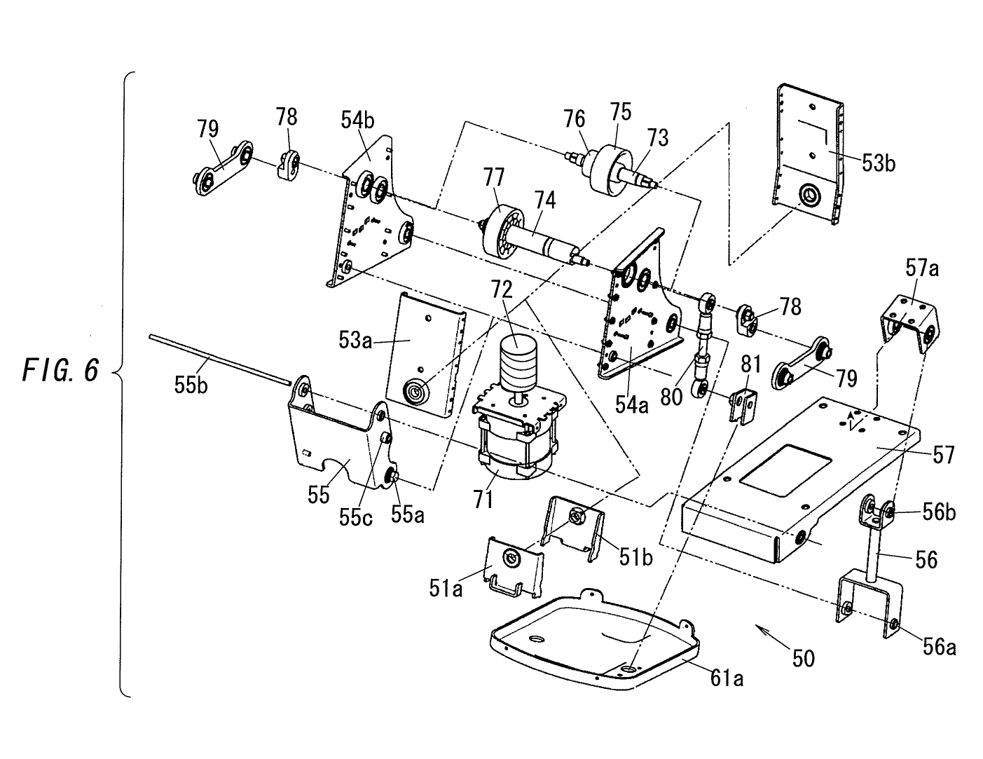

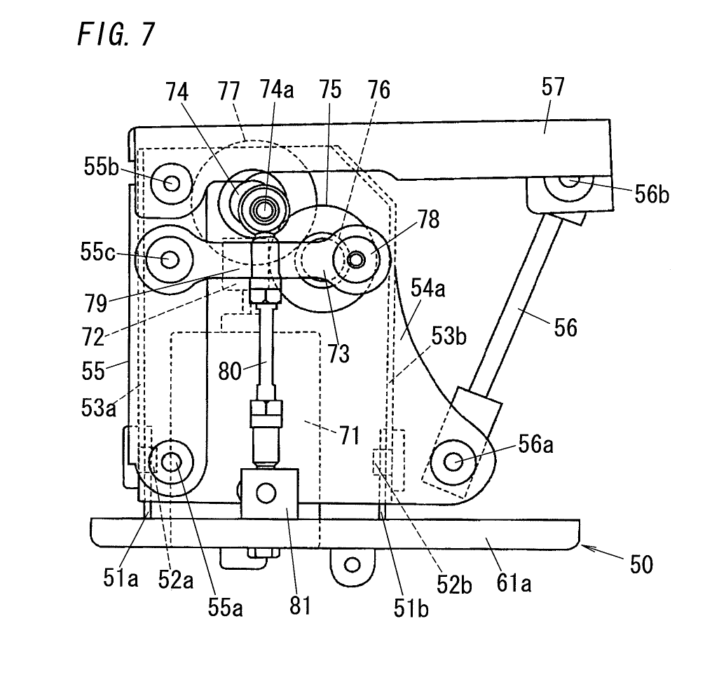

Next, an explanation is made to structure of the drive device 50 with reference to FIGS. 6 and 7. The drive device 50 constructs a mechanism configured to oscillate the seat 120 in cooperation with the pedestal 61a of the up-and-down device 60. The drive unit 50 is movably supported by means of axles 52a and 52b extending through respectively front and rear pair of bearing plates 51a and 51b upstanding from an upper surface of the pedestal 61a, and is allowed to swing in the lateral direction indicated by an arrow N in FIG. 5.

Further, the drive device 50 includes front and rear pair of frame plates 53a and 53b, and left and right pair of frame side plates 54a and 54b connected the frame plates 53a and 53b to constitute rectangular frame. A front link 55 and a rear link 56 which swing about an axis extending in the lateral direction are coupled rotatively to the frame side plates 54a and 54b by means of respective axles 55a and 56a provided at its lower end.

The front link 55 is coupled rotatively to a pedestal plate 57 by means of axles 55b provided at its upper end. The rear link 56 is coupled rotatively to a bearing plate 57a fixed to the pedestal plate 57 by means of axles 56b provided at its upper end. Therefore, a moving range of the pedestal plate 57 is limited such that a front end of the pedestal plate 57 swings about the axles 55a as well as a rear end of the pedestal plate 57 swings about the axles 56a. The seat 120 is attached to the pedestal plate 57. Further, the rear link 56 is greater in length than the front link 55 such that the front end of the pedestal plate 57 is different from the rear end of the pedestal plate 57 in a radius of rotation. Accordingly, an inclination angle of an upper surface of the pedestal plate 57 is varied as the pedestal plate 57 moves forward and rearward. That is, as the pedestal plate 57 moves forward along a back-and-forth direction (direction indicated by the arrow X in FIG. 5) of the seat 120, the front end of the pedestal plate 57 is lowered relative to the rear end thereof. Thereby the inclination angle of the upper surface of the pedestal plate 57 is increased. Therefore, the seat 120 can swing with associated movements in the back-and-forth direction.

There is a motor 71 as a driving source for reciprocating the pedestal plate 57 relative to pedestal 61a. The motor 71 is supported by the frame side plates 54a and 54b such that the motor 71 is in a longitudinal position where an output shaft of the motor 71 turns up. The output shaft of the motor 71 is coupled to a worm 72. The frame side plates 54a and 54b bear a first shaft 73 and a second shaft 74. The first shaft 73 includes a worm wheel 75 engaged with the worm 72 and a gear 76 engaged with a gear 77 provided on the second shaft 74. Both end of the first shaft 73 is coupled respectively to eccentric cranks 78 rotating as the first shaft 73 rotates. Each eccentric crank 78 is coupled to a first end of an arm link 79. Second ends of the arm links 79 are coupled rotatively to axle pins 55c protruded from each of a left surface and a right surface of the front link 55 respectively.

Accordingly, the motor 71 rotates the first shaft 73 through the worm 72 and the worm wheel 75. Further, the eccentric crank 78 rotates, and then the arm links 79 have the front link 55 swing about the axles 55a along the back-and-forth direction. Thereby, the front end of the pedestal plate 57 swings about the axles 55a along the back-and-forth direction (direction indicated by the arrow X in FIG. 5). At this time, since the rear link 56 swings about the axles 56a, the inclination angle of the pedestal plate 57 is varied.

On the other hand, there is an eccentric pin 74a protruded from a first end of the second shaft 74. The eccentric pin 74a is coupled rotatively to an upper end of an eccentric rod 80. The eccentric pin 74a has a lower end coupled rotatively to a connecting fitting 81 fixed to the pedestal 61a. Accordingly, the motor 71 rotates the second shaft 74 through the first shaft 73. As the second shaft 74 rotates, the eccentric pin 74a varies its height position relative to the pedestal 61a. Accordingly, the pedestal plate 57 swings about the axles 52a and 52b along the lateral direction (direction indicated by the arrow N in FIG. 5). It is noted that the motor 71 is placed in a space surrounded by the frame plates 53a and 53b, the frame side plates 54a and 54b, the pedestal 61a, and the pedestal plate 57, in company with the gears 75 to 77. Therefore, the drive device 50 is comparatively compact.

According to the drive device 50 employing above mentioned configuration, the seat 120 moves forward and rightward while moving downward or moves forward and leftward while moving downward. In the present embodiment, a gear ratio of each of gears 76 and 77, and a phase difference between the eccentric crank 78 and the eccentric pin 74a are selected such that a travel path of the seat 120 forms a V-shape configuration (that is, the seat 120 reciprocates twice along the back-and-forth direction while reciprocating along the lateral direction).

Next an explanation is made to the handle post 13. The handle post 13 is attached to the platform 11. The handles 130 which are adapted in use to be held with hands as necessary are equipped at an upper end of the handle post 13. As shown in FIG. 3, the upper end of the handle post 13 has an operation unit (operation display device) 131 placed at the center of the handles 130. The operation unit 131 is configured to enable the exerciser to instruct the operation of such as the drive device 50 and the up-and-down device 60. The operation unit 131 is configured to display an indication concerning an amount of exercise. It is noted that the exerciser M may use the passive exercise machine without holding the handles 130. However, the exerciser M may use the handles 130 before and after using the passive exercise machine, in order to stabilize own upper body.

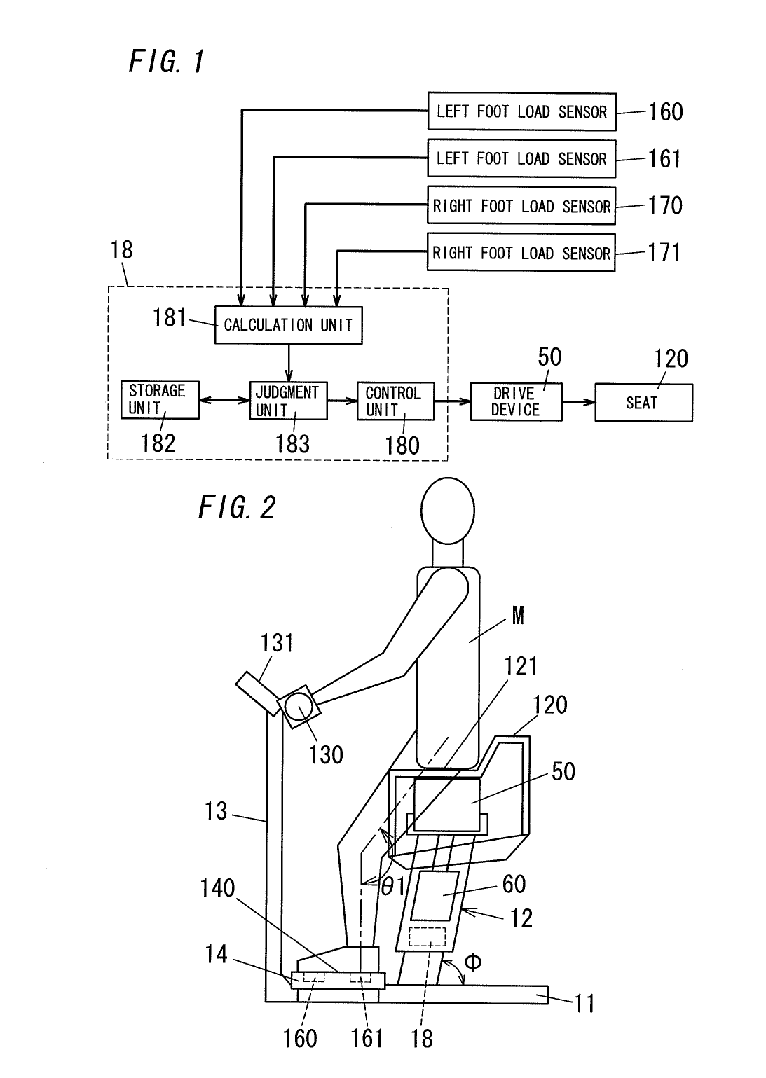

Subsequently, an explanation is made to the signal processor 18 with reference to FIG. 1. The signal processor 18 includes a control unit 180 configured to control the drive device 50, a calculation unit 181 configured to calculate the center point of the load applied respectively to the left-footrest 14 and the right-footrest 15, a storage unit 182 configured to store an ideal characteristics (ideal characteristic curve) indicative of ideal time variation of the center point of the load applied respectively to the left-footrest 14 and the right-footrest 15, and a judgment unit 183 configured to judge whether or not the center point calculated by the calculation unit 181 is analogous to the center point of the ideal characteristic curve.

The calculation unit 181 is configured to receive detection signals respectively from the left foot load sensors 160 and 161 and the right foot load sensors 170 and 171. Upon receiving these detection signals, the calculation unit 181 calculates the center point of the load applied to the left-footrest 14 on the basis of the partial loads detected by the left foot load sensors 160 and 161, and calculates the center point of the load applied to the right-footrest 15 on the basis of the partial loads detected by the right foot load sensors 170 and 171.

Now an explanation is made to calculation of the center point concerning each of the feet of the exerciser M. First, an explanation is made to calculation of the center point concerning the left foot of the exerciser M. It is assumed that, on a straight line L1 connecting the left foot load sensors 160 and 161, a center between the left foot load sensors 160 and 161 provided in the left-footrest 14 is an original point O and a distance between the original point O and the each of the load sensors 160 and 161 is “a”. A position of the left foot load sensor 160 can be expressed as “a”, and a position of the left foot load sensor 161 can be expressed as “−a”. It is assumed that the load (partial load) detected by the left foot load sensor 160 is “f11” and the load (partial load) detected by the left foot load sensor 161 is “f12”. The center point g1 satisfies (g1−a)×f11+{g1−(−a)}×f12=0. Accordingly, g1={a×f11+(−a)×f12}/(f11−f12). Therefore, the calculation unit 181 receives the detection signal from the left foot load sensors 160 and 161 and then obtains the loads f11 and f12 from the received detection signals, thereby calculating the center point g1 concerning the left foot of the exerciser M.

Likewise, It is assumed that the load (partial load) detected by the right foot load sensor 170 is “f21” and the load (partial load) detected by the right foot load sensor 171 is “f22”. The center point g2 of the load applied to the right-footrest 15 satisfies (g2−a)×f21+{g2+a)}×f22=0. Accordingly, g2={a×f21+(−a)×f22}/(f21+f22).

The center points g1 and g2 moves further to the toe side (forward end) as thus obtained values thereof become greater, and moves further to the heel side (rear end) as the values becomes less.

The storage unit 182 is configured to store the ideal characteristic curve of the center point g (g1 and g2) shown in FIG. 4A as a solid line. The ideal characteristic curve of the center point g is predetermined at the time of the production.

The control unit 180 shown in FIG. 1 controls the drive device 50 to oscillate the seat 120 at a predetermined drive speed. The drive speed is selected from a plurality of selectable speed (such as, high speed, middle speed, and low speed) in accordance with such as information concerning the exerciser and a target value of the exerciser.

As shown in FIG. 4B, when the center point of the ideal characteristic curve moves to the forwardmost end (toe end) and the rearwardmost end (heel end), the judgment unit 183 judges for each of the exerciser's feet whether or not a predetermined threshold (e.g., a value b equal to 5% of a distance from the original point O to the center point of the ideal curve) is reached by a displacement of the center point (dotted lines in FIG. 4B), which is calculated at the calculation unit 181, from the center point (solid lines in FIG. 4A) of the ideal curve. The judgment unit 183 makes the judgment for each one reciprocation cycle (starting from the seat 120 moving from the initial point to leftward and forward end and returning back to the initial point). When the displacement is judged to be less than the threshold for each of the left and right feet, the judgment unit 183 determines a normal exercise, and keeps controlling the control unit 180. When, on the other hand, the displacement is judged not to be less than the threshold for any of the left and right feet, the judgment unit 183 determines an abnormal exercise. Upon this occurrence, the control unit 180 counts the number of the events in which the displacement becomes equal or greater than the threshold, and stops the drive unit 50 when a predetermined count (e.g. ten) is reached by the counted number per a predetermined time period (e.g. one minute) greater than the predetermined time interval. Although the control unit 180 may be configured to stop the drive unit 50 immediately in this instance, it is preferred to control the drive device 50 in such a manner as to gradually slow down the movement of the seat 120 until finally stopping the same.

The control unit 180 may control the drive device 50 in a following manner. First, the control unit 180 controls the drive device 50 to decrease the drive speed of the seat 120, when the counted number of times is not less than the predetermined number during the predetermined time. Thereafter, the control unit 180 newly counts the number of times the deviation is not less than the predetermined threshold, and controls the drive device 50 to decrease the drive speed of the seat 120 relative to the previous drive speed, when the newly counted number of times is not less than a prescribed number during the predetermined time. By contrast, the control unit 180 controls the drive device 50 to keep the same drive speed, when the newly counted number of time is less than the prescribed number. When the newly counted number of time is less than the prescribed number for a certain period, the control unit 180 controls the drive device 50 to increase the drive speed of the seat 120. In this instance, the control unit 180 is preferred to control the drive device 50 to increase the drive speed within a range in which an upper limit is the initial drive speed. Therefore, in anticipation of that exerciser M might not use the passive exercise machine properly for reason of that the speed is too fast, the passive exercise machine can move the exerciser M initially at a low speed, and increase the speed after the exerciser M gets used to the passive exercise machine.

As described in the above, according to the present embodiment, the passive exercise machine which the exerciser uses in the sitting posture can judge that the center point is moved forward when the feet resting respectively on the left-footrest 14 and the right-footrest 15 move forward, and can judge that the center point is moved rearward when the feet resting respectively on the left-footrest 14 and the right-footrest 15 move rearward. Therefore, the passive exercise machine can train the muscle of the exerciser effectively.

Moreover, the passive exercise machine controls the drive device 50 to slow down the seat 120. Therefore, the passive exercise machine can instruct the exerciser who is not suitable for the passive exercise machine to stop using the passive exercise machine.

### 2nd Embodiment

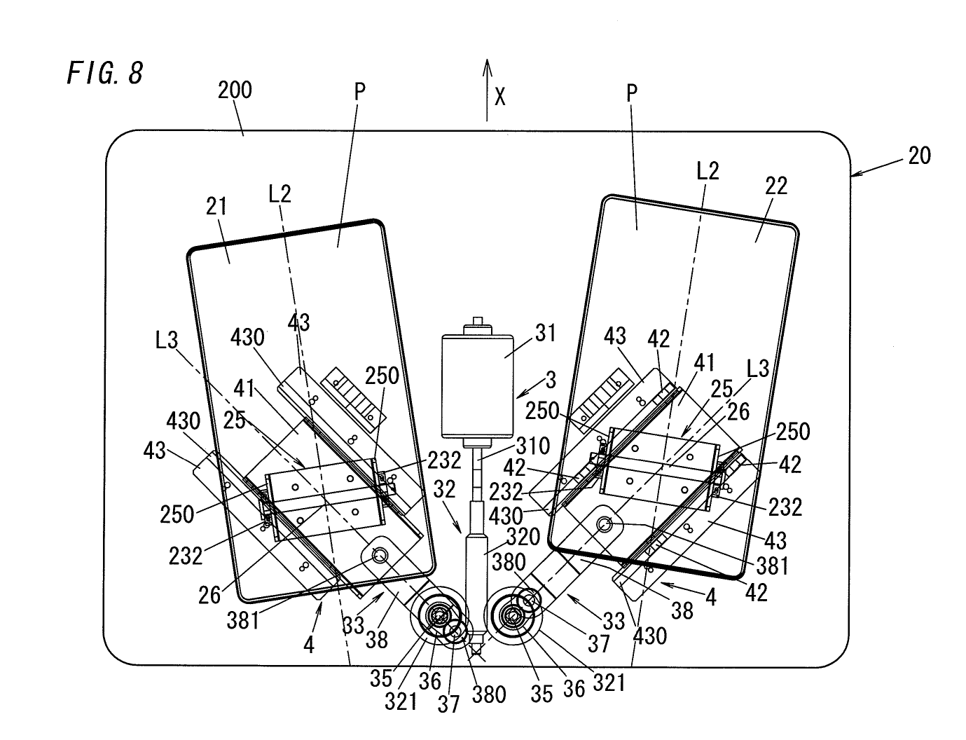

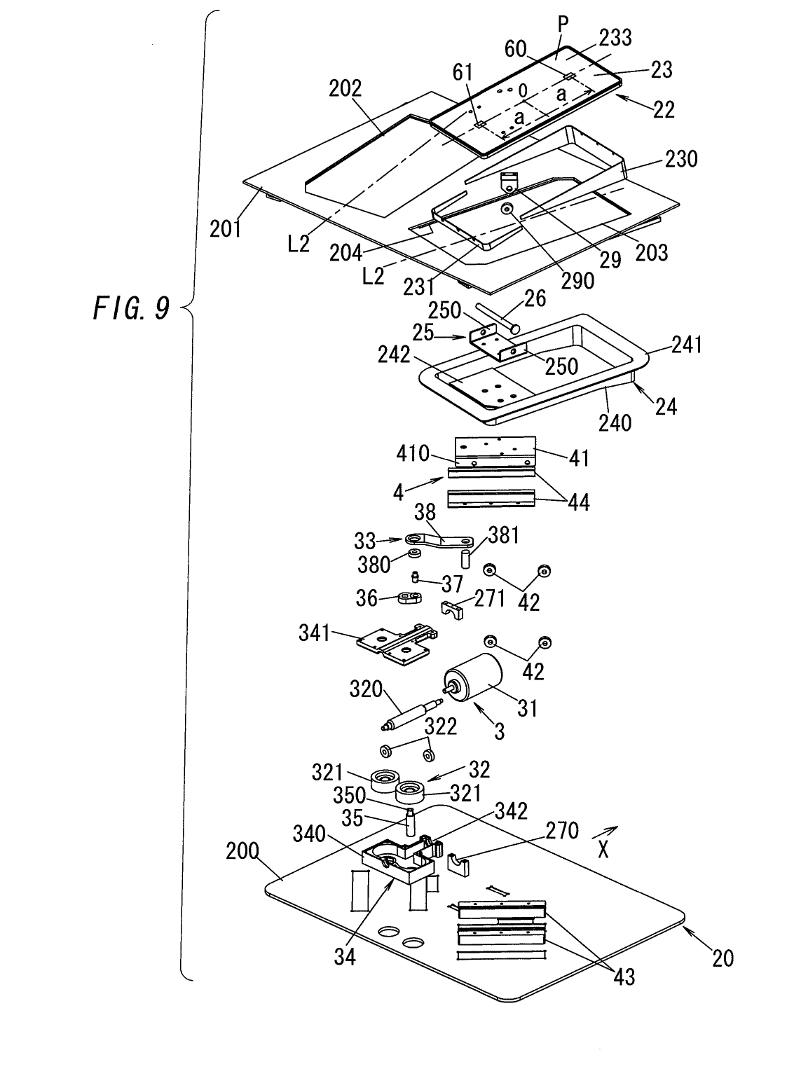

As shown in FIG. 8, a passive exercise machine in accordance with 2nd embodiment is configured to induce muscle activity of the exerciser, and is designed for use by the exerciser in the standing posture. The passive exercise machine of the present embodiment includes a housing 20 constituted by coupling a base plate 200 to an upper plate 201 (see FIG. 9), a left-footrest 21 and a right-footrest 22 respectively including a resting surface P adapted for bearing the left and right feet of the exerciser, and a drive device 3 for moving the left and right footrests 21 and 22.

The base plate 200 is used as a carrier to be placed on a floor, and is designed to have a rectangular parallelepiped shape. The base plate 200 in the present embodiment is configured to have the rectangular parallelepiped shape, although not limited to a peripheral shape. The base plate 200 is provided with the left-footrest 21, the right-footrest 22, and the drive device 3. The left-footrest 21, the right-footrest 22, and the drive device 3 are disposed on the base plate 200. The base plate 200 is illustrated to have a top surface (one surface in a thickness direction of the base plate 200) parallel to the floor when it is placed on the floor. Accordingly, a vertical dimension in FIG. 9 is equal to a vertical dimension of the passive exercise machine to be in use. The forward direction indicated by the arrow X is roughly coincidence with a forward direction of the housing 20.

The upper plate 201 shown in FIG. 9 is formed with two openings 202 and 203 extending in a thickness direction of the upper plate 201 to expose the left and right footrests 21 and 22 (see FIG. 8), respectively. The openings 202 and 203 are each formed into a rectangular shape. The openings 202 and 203 have their longitudinal center lines L2 extending in a crossing relation with respect to the back-and-forth direction (latitudinal direction) of the upper plate 201 (housing 20) such that the distance between the center lines L2 is greater at the front ends of the openings than at the rear ends thereof.

Slide grooves 204 are provided on opposite width ends of each of the openings 202 and 203 in communication therewith for receiving a flange 241 formed on each of footrest covers 24.

As shown in FIG. 9, each of the footrest covers 24 is cooperative with a foot plate 23 to define each of the left and right footrests 21 and 22, and is composed of a main section 240 in the shape of a rectangular barrel and is formed with the flange 241 extending around an open face (upper face) over the entire periphery of the main section 240. The footrest cover 24 has an integrally formed attachment plate 242 at a lower end within the main section 240.

The main section 240 has its lengthwise as well as the width dimensions respectively less than those of the openings 202 and 203, while the flange 241 has such dimensions larger than those of the openings 202 and 203. Further, the slide groove 204 has its opposed bottom spaced by a distance greater than a corresponding distance between the opposite edges of the flange 241. Thus, the footrest cover 24 is allowed to move within the confines of the slide groove 204 with respect to the width as well as lengthwise direction thereof.

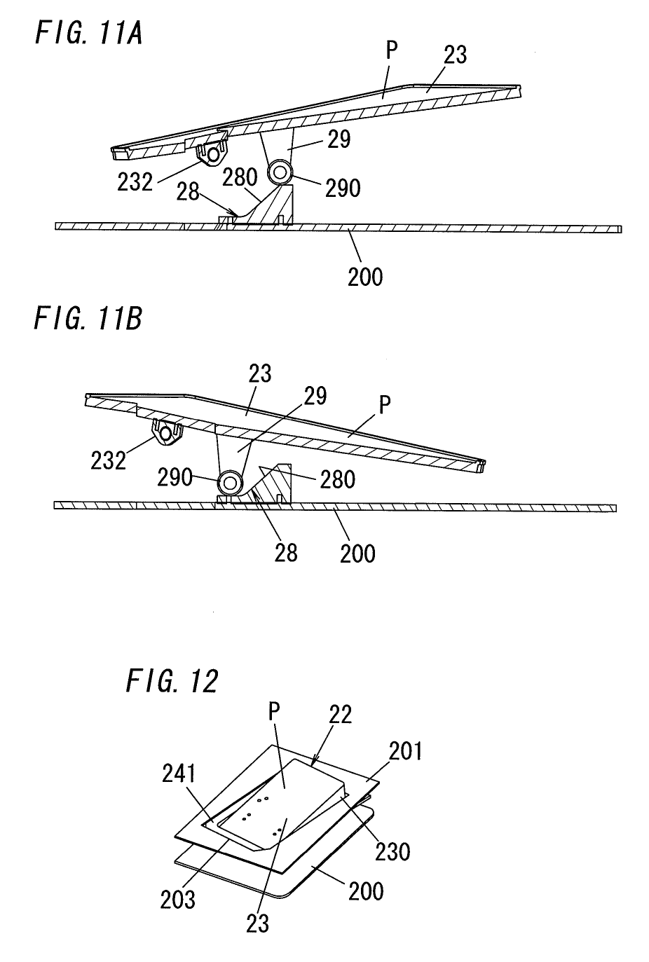

The foot plate 23 is formed into a rectangular plate slightly smaller than the inner periphery of the main section 240 of the footrest cover 24 to have such dimensions as to bear the entire foot of the exerciser. The foot plate 23 holds the left and right feet a predetermined position while the exerciser M rests the left and right feet on foot resting surfaces 233 respectively. The resting surface P is defined by an upper surface of the foot plate 23. The foot plate 23 is made of a material or shaped to have a large coefficient of friction. The foot plate 23 is integrally formed around its lower periphery with generally U-shaped cover members 230 and 231. The foot plate 23 is integrally formed on its bottom at a portion surrounded by the cover members 230 and 231 with a pair of bearings 232 (see FIG. 11) spaced in the width direction of the foot plate 23.

There are two left foot load sensors 210 and 211 incorporated in the foot plate 23 of the left-footrest 21. There are two right foot load sensors 220 and 221 incorporated in the foot plate 23 of the right-footrest 22. The left foot load sensors 210 and 211 and the right foot load sensors 220 and 221 are configured to detect partial loads (that is, loads given by the feet of the exerciser) applied to the respective sensors 210, 211, 220, and 221 (resting surface P).

The two left foot load sensors 210 and 211 are on a line extending along a longitudinal direction of the resting surface P, and are spaced apart by a prescribed distance. In other words, concerning the left-footrest 21, the two left foot load sensors 210 and 211 are spaced in the back-and-forth direction. The above mentioned prescribed distance of the left foot load sensors 210 and 211 is selected such that the two left foot load sensors 210 and 211 can detect the loads applied to the resting surface P corresponding to a vicinity of the base of finger (ball of the thumb) and a vicinity of the heel of the left foot of the exerciser respectively. Likewise, the above mentioned prescribed distance of the right foot load sensors 220 and 221 is selected such that the two right foot load sensors 220 and 221 can detect the loads applied to the resting surface P corresponding to a vicinity of the base of finger (ball of the thumb) and a vicinity of the heel of the right foot of the exerciser respectively.

In the present embodiment, the foot load sensors 210, 211, 220, and 221 detect the load applied to the resting surface P corresponding to the vicinity of the ball of the thumb of the left foot of the exerciser, the load applied to the resting surface P corresponding to the vicinity of the heel of the left foot of the exerciser, the load applied to the resting surface P corresponding to the vicinity of the ball of the thumb of the right foot of the exerciser, and the load applied to the resting surface P corresponding to the vicinity of the heel of the right foot of the exerciser, respectively.

A load sensor made of semiconductors is adopted as each of the left foot load sensors 210 and 211 and the right foot load sensors 220 and 221. A load cell utilizing a strain gauge can be adopted as each of the load sensors 210, 211, 220, and 221. Each of the load sensors 210, 211, 220, and 221 is connected to the drive device 3 via a wire not shown.

A bearing plate 25 of U-shaped cross section is fixed to the top of the attachment plate 242 of the footrest cover 24 to have its open end oriented upwardly, and has its opposed legs 250 in contact respectively with the outer faces of the bearing 232 (see FIG. 11) of the foot plate 23. An axle 26 penetrates through the legs 250 of the bearing plate 25 and the bearings 232 to extend in the width direction of the foot plate 23. The foot plate 23 is allowed to swing about the axle 26 in such a manner that the foot plate 23 moves up and down at its lengthwise forward and rearward ends (see FIG. 12). The cover members 230 and 231 are provided to conceal a gap formed between the foot plate 23 and the footrest cover 24 while the foot plate 23 swings relative to the footrest cover 24.

A truck 41 of U-shaped cross section is fixed to the bottom of the attachment plate 242 of the footrest cover 24 to have its open end oriented downwardly, and is provided on each exterior face of its legs 410 with two wheels 42. The base plate 200 is formed with two fixed rails 43 for each of the left and right footrests 21 and 22 such that the truck 41 is placed on the rails 43 with the wheels 42 roll in the rail grooves 430 in the upper end of the rails 43. A derailment prevention plate 44 is provided on top of the rail 43 for preventing the wheels 42 from running off the rail grooves 430.

By the way, the rails 43 extend in a direction different from the lengthwise direction of the openings 202 and 203 in the housing 20. As described in the above, the openings 202 and 203 have their individual longitudinal center lines L2 crossed with each other so as to be spaced by a larger distance at the forward ends than at the rearward ends. Also, the rails 43 have their individual longitudinal directions crossed with each other in the like manner.

However, the rails 43 are inclined in relation to the back-and-forth direction of the housing 20 at a large angle than the openings 202 and 203. For example, when the openings 202 and 203 have their lengths inclined relative to the back-and-forth direction of the housing 20 at an angle of 30°, the rails 43 have its length inclined at an angle of 45°. In short, the rails 43 are oriented to such a direction as to prevent an increase of shearing force acting on the knee joints while the left and right footrests 21 and 22 are moved along the rails 43 in a condition that the exerciser's feet are placed thereon with each center line of the feet aligned with each of the length of the openings 202 and 203. The left and right footrests 21 and 22 are moved along the individual travel paths of shifting their positions both in the back-and-forth direction and the lateral direction. It is possible to determine the orientation of the rails 43 such that the left and right footrests 21 and 22 are moved either in the back-and-forth direction or the lateral direction.

With the above arrangement, the left and right footrests 21 and 22 are allowed to move respectively along the longitudinal directions L3 of the rails 43. Because of that the rails 43 have their longitudinal directions L3 crossed respectively with the lengthwise center lines L2 of the openings 202 and 203, the foot plate 23 and the footrest cover 24 are allowed to move within the openings 202 and 203 along the directions crossing with the lengthwise direction of the openings 202 and 203. Therefore, the truck 41, the wheels 42, the rails 43, and the derailment prevention plates 44 function as a guide 4 restricting the travel path of each of the left-footrest 21 and the right-footrest 22.

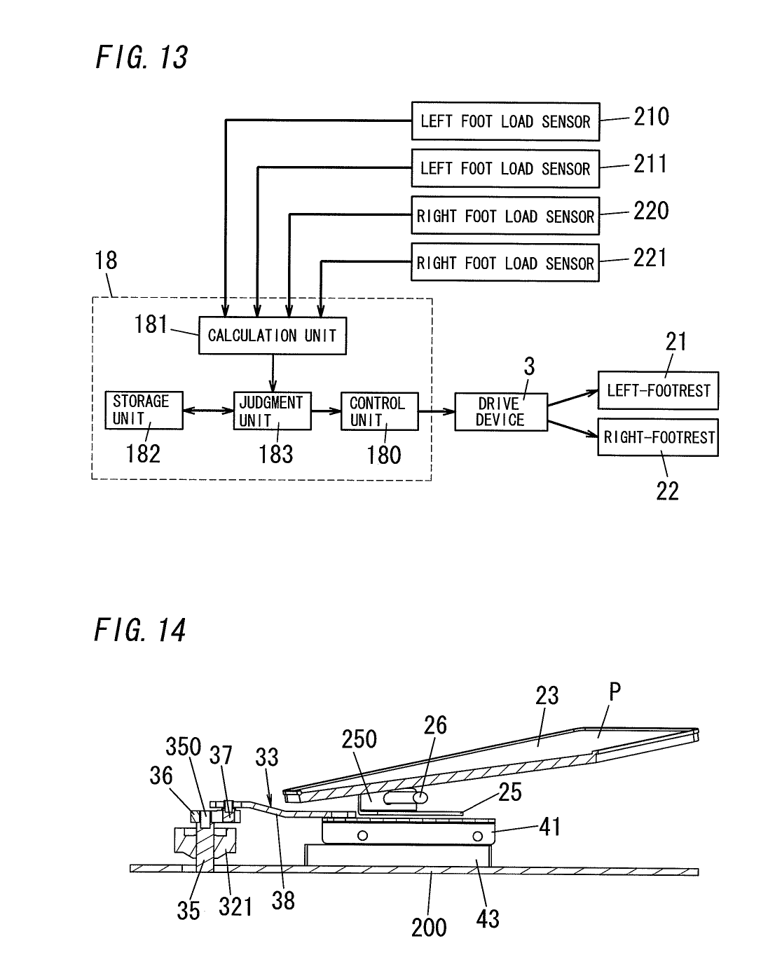

As shown in FIG. 8, the drive device 3 configured to move the left-footrest 21 and the right-footrest 22 includes, as mechanical components, an electric motor (rotary motor) 31 generating a rotary driving force to move the left-footrest 21 and the right-footrest 22, a router 32 for transmitting the rotary driving force of the motor 31 to the left and right footrests 21 and 22, and reciprocators 33 for using the driving force to reciprocate the trucks 41 respectively along the rails 43. The router 32 is coupled to an output shaft 310 of the motor 31. It is noted that the mechanical component, such as the router 32 and the reciprocators 33 is not shown in FIG. 13.

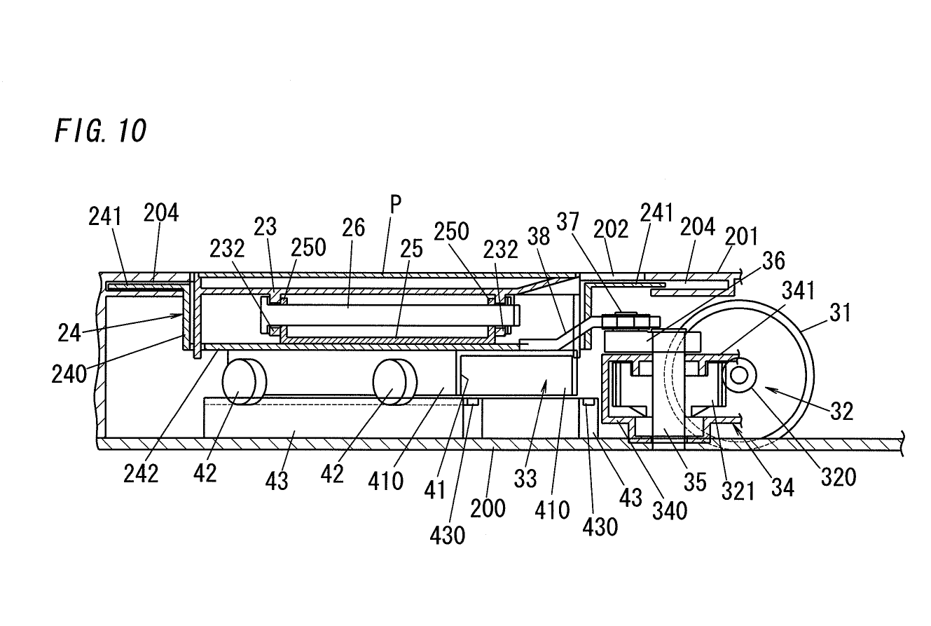

The router 32 includes a worm (first gear) 320 coupled to the output shaft 310 of the motor 31, and a pair of worm wheels (second gears) 321. The worm 320 and the two worm wheels 321 are held within a gearbox 34 (see FIG. 10) fixed to the base plate 200. The gearbox 34 is composed of a gear case 340 with a top opening, and a lid 341 fitted in the opening of the gear case 340. A pair of bearings 322 is mounted between the gear case 340 and the lid 341 to bear the opposite longitudinal ends of the worm 320.

Extending through the worm wheel 321 is a rotary shaft 35 which is held by the gear case 340 and the lid 341 and is coupled to the worm wheel 321 to be driven thereby to rotate. The rotary shaft 35 is formed at its upper end with a coupling section 350 with non-circular cross-section (rectangular one in the illustrated instance).

The motor 31 is mounted on a holder member 342 of the gear case 340 and on a holder plate 270 secured to the base plate 200, and is fixed to the base plate 200 by means of the lid 341 fitted over the gear case 340 and a retainer plate 271 coupled to the holder plate 270.

As shown in FIG. 14, the reciprocator 33 includes a crank plate 36 coupled at its one end to the coupling section 350 of the rotary shaft 35, and a crank rod 38 coupled to the crank plate 36 by means of a crank shaft 37. The crank shaft 37 has its one end fixed to the crank plate 36 and has the other end received in the bearing 380 carried on one end of the crank rod 38. That is, the crank rod 38 has its one end rotatively coupled to the crank plate 36, while the other end of the crank rod 38 is coupled to the truck 41 by means of an axle 381 so as to be rotatively coupled thereto.

As is apparent from the above, the crank rod 38 functions as a motion converter to translate the rotary motion of the worm wheel 321 into a reciprocatory motion of the truck 41. Since the crank rod 38 is provided for each of the worm wheels 321 and the trucks 41 are provided respectively to the left and right footrests 21 and 22, the crank rods 38 function as the individual motion converters for translating the rotary motion of the worm wheels 321 into the reciprocating motions of the left and right footrests 21 and 22.

Although the present embodiment is configured to divide the driving force at the router 32 and transmit the divided driving force to the reciprocators 33, it is equally possible to generate the reciprocating driving force at the reciprocator 33 and divide the same at the router 32.

As described in the above, the truck 41 has its travel path restricted by the wheels 42 and the rails 43 so that the truck 41 reciprocates along the length L3 of the rails 43 as the worm wheel 321 rotates. That is, the rotation of the motor 31 is transmitted to the crank plate 36 by way of the worm 320 and the worm wheel 321, so that the crank rod 38 coupled to the crank plate 36 causes the truck 15 to reciprocate linearly along the rails 43. Whereby, the left and right footrests 21 and 22 are driven to reciprocate respectively along the length of the rails 43.

In the present embodiment, the worm 320 and the two worm wheels 321 are responsible for routing the driving force into two channels respectively for driving the left and right footrests 21 and 22 so that the drive device 3 drives the left and right footrests 21 and 22 in a manner linked to each other. The worm wheels 321 are engaged with the worm 320 at different portions spaced apart by 180° such that the right footrest 22 comes to the forward end of its movable range when the left footrest 21 comes to the rear end of its movable range. As the left footrest 21 comes to the right end of its movable range when it comes to the rear end of the movable range, and the right footrest 22 comes to the right end of its movable range when it comes to the forward end of the movable range, the left and right footrests 21 and 22 shift in the same direction along the lateral direction.

As apparent from the above, it is possible to give a desired phase difference of the movement between the left and right footrests 21 and 22 by varying positions of engaging the worm wheels 321 with the worm 320. When the device is used by the exerciser at the standing posture with one's feet placed on the left and right footrests 21 and 22, the phase difference of 180° is effective to minimize the shifting of the exerciser's weight in the back-and-forth direction, enabling the exercise even by the exerciser suffering from lowered balancing capability. Alternatively, when no phase difference is given, the device necessitates the shifting movement of the exerciser's weight in the back-and-forth direction, thereby developing an exercise not only for the leg muscles but also for lower back muscles of the exerciser maintaining the balancing capability.

By the way, the foot plate 23 provided on each of the left and right footrests 21 and 22 is allowed to swing about the axles 26 relative to the footrest cover 24, enabling to vary the height positions of the forward end as well as the rearward end of the foot plate 23. Thus, the height positions of the toe and the heel of the foot placed on the foot plate 23 can be varied for enabling the plantarflexion and dorsiflexion of the ankle joint.

Now, as shown in FIG. 11, in order to link the swinging movement of the foot plate 23 about the axle 26 with the reciprocating movement thereof along the rail 43, the base plate 200 is provided at a portion along the travel path of the foot plate 23 with a guide surface 28 including an inclination 280. In this connection, the foot plate 23 is provided on its bottom with a follower projection 29 which comes into engagement with the guide surface 28. In the illustrated embodiment, the inclination 280 extends the full length of the guide surface 28 at a constant angle relative to the upper face of the base plate 200. The guide surface 28 is not particularly delimited to the illustrated embodiment and may be shaped to have the inclination partially along its length. Although it is sufficient that the follower projection 29 is formed from a material and/or shaped into a configuration to have a tip of small coefficient of friction, the follower projection 29 is preferred to have at its top a roller 290 which comes into rolling contact with the guide surface 28, as illustrated in the figure.

The follower projection 29, which is arranged to come into rolling contact with the guide surface 28, rides up and down the inclination 280 while each of the left and right footrests 21 and 22 is driven by the motor 31 to reciprocates, thereby swinging the foot plate 23 about the axle 26 to vary its tilt angle relative to the base plate 200, and therefore enabling the plantarflexion and dorsiflexion at the ankle joint.

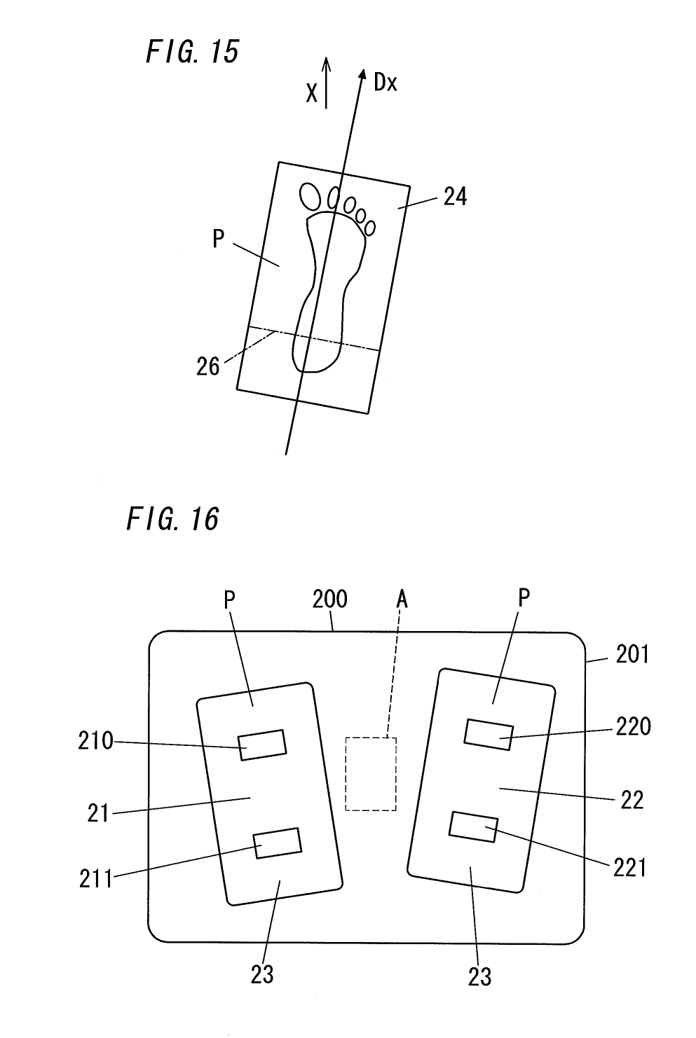

When using the device, the exerciser is first required to stand with one's feet placed respectively on the left and right footrests 21 and 22 which are rest respective at their initial positions and then to start the drive device 3. As shown in FIG. 15, each of the left and right footrests 21 and 22 is located such that the longitudinal direction Dx of each of the left and right footrests 21 and 22 is inclined at a predetermined angle (for example 9°) relative to the back-and-forth direction (the direction indicated by the arrow X). Therefore, the exerciser can take the natural posture without suffering from twisted feet when standing on the left and right footrests 21 and 22.

At the initial positions, the left and right footrests 21 and 22 are located at the same level along the back-and-forth direction. That is, the left and right footrests 21 and 22 lie on a line extending along the lateral direction when they are at the initial positions. Accordingly, when the exerciser stands on the left and right footrests 21 and 22 of the initial positions, a vertical line depending from the weight center of the exerciser passes through a center between the left and right footrests 21 and 22.

As apparent from the above, as shown in FIG. 8, the drive device 3 can drive the left and right footrests 21 and 22 to move in the back-and-forth direction and at the same time to move in the lateral direction in the linked manner to each other. The left and right footrests 21 and 22 are driven to reciprocate linearly along the rails 43, respectively, so as to move in directions different from the lengthwise directions of the feet. For example, the left and right footrests 21 and 22 move in the directions inclined at an angle of 45° relative to the back-and-forth direction of the housing 20, over the travel distance of 20 mm, for example.

Also as discussed in the above, the foot plate 23 is driven to swing about the axle 26 as each of the left and right footrests 21 and 22 reciprocates along the rail 43. While the foot plate 23 is moving, the follower projection 29 rides up and down the inclination 280 of the guide surface 28 to cause the dorsiflexion of the ankle joint when each of the left and right footrests 21 and 22 comes to its forward end position, and the plantarflexion when it comes to its rearward end position. The axle 26 is positioned nearer to the heel within the length of the foot bottom. Each of the dorsiflexion and plantarflexion is realized at the tilt angle of about 10° relative to a reference plane defined by the upper surface of the base plate 200.

While the left-footrest 21 is moves forward and leftward, the load from the left foot of the exerciser to the left-footrest 21 becomes greater toward the toe side (front side) than at the heel side. As a result, the center point of the load applied to the left-footrest 21 moves to the toe side. Thereafter, while the left-footrest 21 is subsequently returning to the initial position, the load from the left foot of the exerciser to the left-footrest 21 becomes greater toward the heel side (rear side) than at the toe side. As a result, the center point of the load applied to the left-footrest 21 moves to the heel side. On the other hand, while the right-footrest 22 moves forward and rightward, the load from the right foot of the exerciser to the right-footrest 22 becomes greater toward the toe side (front side) than at the heel side. As a result, the center point of the load applied to the right-footrest 22 moves to the toe side. While the right-footrest 22 is subsequently returning to the initial position, the load from the right foot of the exerciser to the right-footrest 22 becomes greater toward the heel side (rear side) than at the toe side. As a result, the center point of the load applied to the right-footrest 22 moves to the heel side.

Next, an explanation is made to a signal processing with reference to FIG. 13. A signal processor 18 includes a control unit 180 configured to control an operation of the drive device 3, a calculation unit 181 configured to calculate the center point of the load applied respectively to the left-footrest and the right-footrest, a storage unit 182 configured to store the ideal characteristics (ideal characteristic curve) indicative of ideal time variation of the center point, and a judgment unit 183 configured to judge whether or not the center point calculated by the calculation unit 181 is analogous to the center point of the ideal characteristic curve.

The calculation unit 181 is configured to receive detection signals respectively from a plurality (in the present embodiment, the number of the left foot load sensors is two) of the left foot load sensors 210 and 211 incorporated in the left-footrest 21 and a plurality (in the present embodiment, the number of the right foot load sensors is two) of the right foot load sensors 220 and 221 incorporated in the right-footrest 22. Upon receiving these detection signals, the calculation unit 181 calculates the center point of the load applied to the left-footrest 21 on the basis of the partial loads detected by the left foot load sensors 210 and 211, and calculates the center point of the load applied to the right-footrest 22 on the basis of the partial loads detected by the right foot load sensors 220 and 221.

Now an explanation is made to calculation of the center point concerning each of the feet of the exerciser. First, an explanation is made to calculation of the center point concerning the left foot of the exerciser. It is assumed that, on a straight line connecting the left foot load sensors 210 and 211, a center between the left foot load sensors 210 and 211 provided in the left-footrest 21 is an original point O and a distance between the original point O and the each of the load sensors 210 and 211 is “a”. A position of the left foot load sensor 210 can be expressed as “a”, and a position of the left foot load sensor 211 can be expressed as “−a”. It is assumed that the load (partial load) detected by the left foot load sensor 210 is “f11” and the load (partial load) detected by the left foot load sensor 211 is “f12”. The center point g1 satisfies (g1−a)×f11+{g1+a)}×f12=0. Accordingly, g1={a×f11+(−a)×f12}/(f11+f12). Therefore, the calculation unit 51 receives the detection signal from the left foot load sensors 210 and 211 and then obtains the loads f11 and f12 from the received detection signals, thereby calculating the center point g1 concerning the left foot of the exerciser.

Likewise, It is assumed that the load (partial load) detected by the right foot load sensor 220 is “f21” and the load (partial load) detected by the right foot load sensor 221 is “f22”. The center point g2 of the load applied to the right-footrest 22 satisfies (g2−a)×f21+{g2−(−a)}×f22=0. Accordingly, g2={a×f21+(−a)×f22}/(f21+f22).

An increase of a value of the center points g1 and g2 indicates that the center points g1 and g2 moves toward the toe side (front side), and a decrease of a value of the center points g1 and g2 indicates that the center points g1 and g2 moves toward the heel side (rear side), respectively.

The storage unit 182 is configured to store the ideal characteristic curve of the center point g (g1 and g2) shown in FIG. 4A as a solid line. The ideal characteristic curve of the center point g is predetermined at the time of the production.

The control unit 180 shown in FIG. 13 is, for example, a micro computer, and controls an electrical power supplied to the motor 31 from a power source not shown, thereby activating the motor 31, deactivating the motor 31, or adjusting the number of rotations of the motor 31. Further, the control unit 180 activates the motor 31 when a switch (not shown) provided on the housing 1 is turned on, and deactivates the motor 31 when the switch is turned off. Moreover, the control unit 180 controls the drive device 3 to move the left-footrest 21 and the right-footrest 22 at a predetermined drive speed. The drive speed is selected from a plurality of selectable speed (such as, high speed, middle speed, and low speed) in accordance with such as information concerning the exerciser and a target value of the exerciser, before the left-footrest 21 and the right-footrest 22 are moved.

As shown in FIG. 4B, the judgment unit 183 acts, when the center point of the ideal characteristic curve moves to the forwardmost end (toe end) and the rearwardmost end (heel end), to judge for each of the exerciser's feet whether or not the predetermined threshold (e.g., a value b equal to 5% of the distance from the original point O to the center point of the ideal characteristic curve) is reached by the displacement of the center point (dotted lines in FIG. 4B) as calculated at the calculation unit 181 from the center point (solid lines in FIG. 4A) of the ideal characteristic curve. The judgment unit 183 makes the judgment for each one reciprocation cycle (starting from the left footrest 21 or right footrest 22 moving from the initial point to leftward and forward end and returning back to the initial point).

The control unit 180 determines a normal exercise when the deviation is less than the predetermined threshold, and then controls the drive device 3 to continue moving the left-footrest 21 and the right-footrest 22. Meanwhile, the control unit 180 determines an abnormal exercise when the deviation concerning the left foot and/or the right foot is not less than the predetermined threshold. The control unit 180 counts the number of times the deviation is not less than the predetermined threshold. The control unit 180 stops the drive device 3 when the counted number of times is not less than a predetermined number (for example, 10) during a predetermined time (for example, 1 minute) longer than a length of the regular interval. Although the control unit 180 may stop the drive device 3 immediately in this instance, it is preferred to control the drive device 3 in such a manner as to gradually slow down the movement of the left-footrest 21 and the right-footrest 22 until finally stopping the same.

The control unit 180 may control the drive device 3 in a following manner. First, the control unit 180 controls the drive device 3 to decrease the drive speed of the left-footrest 21 and the right-footrest 22, when the counted number of times is not less than the predetermined number during the predetermined time. Thereafter, the control unit 180 newly counts the number of times the deviation is not less than the predetermined threshold, and controls the drive device 3 to decrease the drive speed of the left-footrest 21 and the right-footrest 22 relative to the previous drive speed, when the newly counted number of times is not less than a prescribed number during the predetermined time. By contrast, the control unit 180 controls the drive device 3 to keep the same drive speed, when the newly counted number of time is less than the prescribed number. When the newly counted number of time is less than the prescribed number for a certain period, the control unit 180 controls the drive device 3 to increase the drive speed of the left-footrest 21 and the right-footrest 22. In this instance, the control unit 180 is preferred to control the drive device 3 to increase the drive speed within a range in which an upper limit is the initial drive speed. In anticipation of that exerciser might not use the passive exercise machine properly for reason of that the left-footrest 21 and the right-footrest 22 are moving too fast, the passive exercise machine may be configured to move the left-footrest 21 and the right-footrest 22 initially at a low speed, and speed up the left-footrest 21 and the right-footrest 22 after the exerciser gets used to the passive exercise machine.

Further, the judgment unit 183 is configured to judge whether or not the exerciser is in a predetermined exercise position (in the present embodiment, the exerciser stands on the left-footrest 21 and the right-footrest 22 with one's feet resting respectively on the left-footrest 21 and the right-footrest 22), on the basis of the partial loads detected by each of the left foot load sensors 210 and 211 and each of the right foot load sensors 220 and 221.

The judgment unit 183 is configured to calculate a projected weight center of the exerciser. The projected weight center is defined as a point to which the weight center of the exerciser projects vertically down on a horizontal plane in which the left foot load sensors 210 and 211 and the right foot load sensors 220 and 221 are arranged. The horizontal plane is defined by the upper surface of the base plate 200 or the housing 20. The judgment unit 183 is configured to judge that the exerciser is out of the predetermined exercise position when the projected weight center deviates from a prescribed range A (see, FIG. 16) in the horizontal plane.

The judgment unit 183 calculates the projected weight center by referencing the individual locations of the left foot load sensors 210 and 211 and the right foot load sensors 220 and 221, as well as the partial loads respectively detected at the load sensors 210, 211, 220, and 221. For example, the judgment unit 183 calculates the weight center of the exerciser's foot in the resting surface P (a point to which the weight center of the exerciser's foot projects vertically down on the resting surface P in the horizontal plane) and the load applied thereto, based on the partial loads respectively detected at the load sensors 210, 211, 220, and 221. Subsequently, the judgment unit 183 calculates the projected weight center based on the calculated weight center of the exerciser's foot in the resting surface P and the calculated load applied thereto. It is noted that this instance shows only an example of the calculation of the projected weight center and gives no limitation about the calculation of the projected weight center of the present embodiment. In short, the projected weight center may be calculated in total reflection of the respective locations of the load sensors 210, 211, 220, and 221 as well as the partial loads respectively detected at the sensors 210, 211, 220, and 221. It is noted that the respective locations of the load sensors 210, 211, 220, and 221 in the base plate 200 may be calculated by use of, for example, a rotating angle of the motor 31 and respective locations of the load sensors 210, 211, 220, and 221 in the resting surface P.

By the way, it is sufficient that the prescribed range A which is a criterion for judging whether or not the exerciser is in the predetermined exercise position is determined based on a trend (variation) of the projected weight center in which the exerciser uses actually the passive exercise machine. For example, it is assumed that the foot plate 23 is driven to swing about the axle 26 as each of the left and right footrests 21 and 22 reciprocates along the rail 43, in order to cause the dorsiflexion of the ankle joint when each of the left and right footrests 21 and 22 comes to its forward end position, and the plantarflexion when it comes to its rearward end position. During the dorsiflexion of the ankle joint, the vicinity of the heel bears the exerciser's weight. This causes the projected weight center to be positioned at the rear side within the resting surface P. During the plantarflexion of the ankle joint, the vicinity of the ball of the thumb bears the exerciser's weight. This causes the projected weight center to be positioned at the front side within the resting surface P. As is apparent from the above, a movement distance of the projected weight center along the back-and-forth direction of the exerciser is shortened when the phase difference of the movement between the left and right footrests 21 and 22 is 180°. In this instance, the prescribed range A is a range at a vicinity of a center of the upper surface of the base plate 200.

Now, it is assumed that the foot plate 23 swings about the axel 26 in opposite to the above (that is, the passive exercise machine causes the plantarflexion of the ankle joint when each of the left and right footrests 21 and 22 comes to its forward end position, and the dorsiflexion when it comes to its rearward end position). In this instance, as is apparent from the above, the movement distance of the projected weight center along the back-and-forth direction of the exerciser is shortened when the phase difference of the movement between the left and right footrests 21 and 22 is 180°. Therefore, the prescribed range A is a range at a vicinity of the center of the upper surface of the base plate 200.

FIG. 16 shows a rectangular-shaped range as the prescribed range A. It shows only an example of the prescribed range A, and gives no limitation about the prescribed range A of the present invention. The prescribed range A is determined by a condition (a kind of the movement of the left-footrest 21 and the right-footrest 22) of the passive exercise induced by the passive exercise machine. Accordingly, the prescribed range A is not limited to the rectangular-shaped range shown in FIG. 16, and may have a circular shape or a more complicated shape.

The prescribed range A may be determined by the use of a moving average of the trend in order to improve accuracy of judgment of the judgment unit 183.

The control unit 180 stops the motor 31 to stop the left-footrest 21 and the right-footrest 22 when the judgment unit judges the exerciser is not in the exercise position. The control unit 180 decreases the number of rotations of the motor 31 gradually and finally stops the motor 31 because to stop the left-footrest 21 and the right-footrest suddenly may be dangerous for the exerciser. Even when the switch is turned on, the control unit 180 does not activate the motor 31 for the exerciser's safety while the judgment unit judges the exerciser is not in the exercise position.

Next, an explanation is made to an operation of the passive exercise machine of the present embodiment. It is assumed that, in an initial condition, the switch is kept turned off and the left-footrest 21 and the right-footrest 22 are located at a predetermined stop position.

The switch is turned on in order to operate the passive exercise machine from the initial condition. When the exerciser does not stand on the left-footrest 21 and the right-footrest 22 with one's feet resting respectively on the left-footrest 21 and the right-footrest 22 (that is, the exerciser is not in the predetermined exercise position) at a timing in which the switch is turned on, the judgment unit 183 judges that the exerciser is not in the predetermined exercise position. Therefore, the control unit 180 does not activate the motor 31 even when the switch is turned on. Accordingly, in order to activate the passive exercise machine, the exerciser is required to turn on the switch while standing on the left-footrest 21 and the right-footrest 22 with one's feet resting respectively on the left-footrest 21 and the right-footrest 22 (that is, the exerciser is in the predetermined exercise position).

The motor 31 can drive the left and right footrests 21 and 22 to move in the back-and-forth direction and at the same time to move in the lateral direction in the linked manner to each other. The left and right footrests 21 and 22 are driven to reciprocate linearly along the rails 43, respectively, so as to move in directions different from the lengthwise directions of the feet. For example, the left and right footrests 21 and 22 move in the directions inclined at an angle of 45° relative to the back-and-forth direction of the housing 20, over the travel distance of 20 mm, for example.

Further, the foot plate 23 is driven to swing about the axle 26 as each of the left and right footrests 21 and 22 reciprocates along the rail 43. While the foot plate 23 is moving, the follower projection 29 rides up and down the inclination 280 of the guide surface 28 to cause the dorsiflexion of the ankle joint when each of the left and right footrests 21 and 22 comes to its forward end position, and the plantarflexion when it comes to its rearward end position. The axle 26 is positioned nearer to the heel within the length of the foot bottom. Each of the dorsiflexion and plantarflexion is realized at the tilt angle of about 10° relative to the reference plane defined by the upper surface of the base plate 200. The dorsiflextion and the plantarflexion can be made respectively at the rearward end position and the forward end position of each of the left and right footrests 21 and 22 in opposite relation to the above. Also, the tilt angle relative to the reference plane can be selected differently from the above mentioned angle. Such modified operation can be easily realized by an appropriate shaped guide surface 28.

As described in the above, the movement of the left-footrest 21 and the right-footrest 22 has the exerciser make the passive exercise.

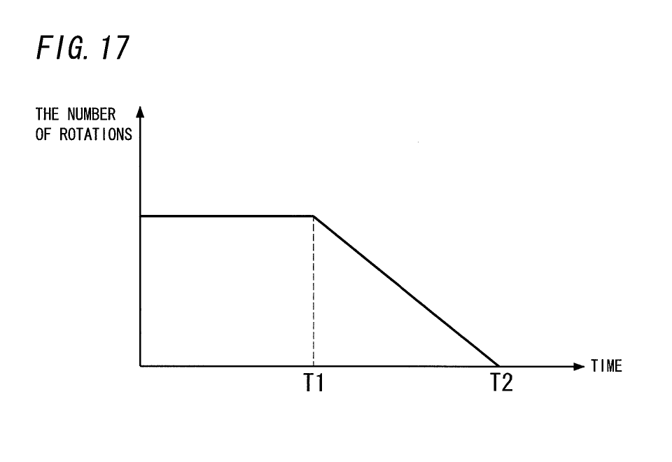

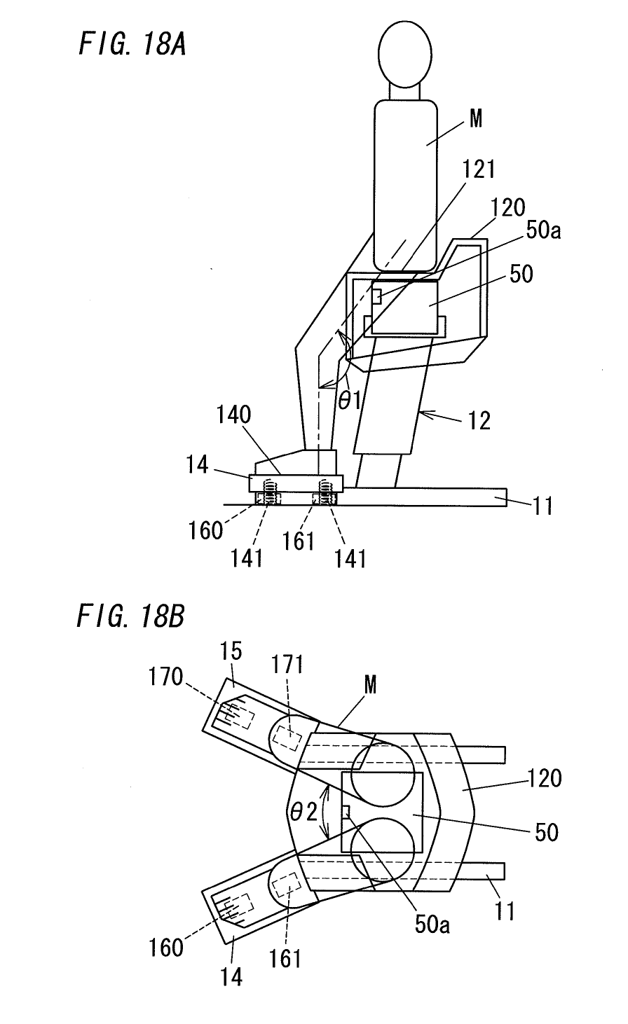

It is assumed that the exerciser loses a balance and leaves from the predetermined exercise position of the passive exercise machine in order to prevent overturn, while the exerciser makes the passive exercise by the use of the passive exercise machine. For example, the exerciser moves own left foot from the left-footrest 21. In this instance, the load detected by the left foot load sensors 210 and 211 provided on the left-footrest 21 becomes less than a predetermined threshold, therefore, the judgment unit 183 judging that the exerciser is out of the predetermined exercise position. This causes the control unit 180 to stop the motor 31. At this time, the control unit 180 decreases an electrical current supplied to the motor 31 gradually, thereby decreasing the number of rotation of the motor 31 and finally stopping the motor 31. FIG. 17 is a chart exemplifying relation between the number of rotation of the motor 31 and time. Time T1 indicates time when the exerciser just leaves the predetermined exercise position, and time T2 indicates time when the motor 31 just stops. It is noted that the control unit 180 activates the motor 31 to restart the passive exercise when the exerciser returns to the predetermined exercise position.

As described in the above, according to the present embodiment, the passive exercise machine which the exerciser uses in the standing posture can judge that the center point is moved forward when the feet resting respectively on the left-footrest 21 and the right-footrest 22 move forward, and can judge that the center point is moved rearward when the feet resting respectively on the left-footrest 21 and the right-footrest 22 move rearward. Therefore, the passive exercise machine can train the muscle of the exerciser effectively.

Moreover, the passive exercise machine controls the drive device 3 to slow down the left-footrest 21 and the right-footrest 22. Therefore, the passive exercise machine can instruct the exerciser who is not suitable for the passive exercise machine to stop using the passive exercise machine.

Further, in the above mentioned passive exercise machine of the present embodiment, judgment unit 183 is configured to calculate the projected weight center of the exerciser based on the respective locations of the left foot load sensors 210 and 211 and the right foot load sensors 220 and 221, as well as the partial loads respectively detected at the left foot load sensors 210 and 211 and the right foot load sensors 220 and 221. The judgment unit 183 is configured to judge that the exerciser is out of the predetermined exercise position when the projected weight center deviates from the prescribed range A in the horizontal plane defined by the base plate 200.

As described in the above, the passive exercise machine of the present embodiment stops moving the left-footrest 21 and the right-footrest 22 when the exerciser fails to be in the predetermined exercise position while moving the left-footrest 21 and the right-footrest 22 (while the passive exercise machine is in use). Therefore, the passive exercise machine can avoid the exerciser uses the passive exercise machine with an improper posture. The passive exercise machine prevents the exerciser from being injured, thereby improving its safety.

Especially, the passive exercise machine of the present embodiment can judge that the exerciser is out of the predetermined exercise position before the entire foot of the exerciser departs from the resting surface P, by means of calculating the projected weight center of the exerciser. For example, before the exerciser loses a balance of an every part of the body, in short, when the exerciser loses a balance of the upper part of the body, the passive exercise machine can stop moving the left-footrest and the right-footrest. Accordingly, the passive exercise machine more improves its safety.

Further, the two left foot load sensors 210 and 211 and the two right foot load sensors 220 and 221 are incorporated in the different portions of the left-footrest 21 and the right-footrest 22 arranged in the longitudinal direction of the left-footrest 21 and the right-footrest 22, respectively. The passive exercise machine can improve a detection accuracy of variation of the projected weight center of the exerciser in the longitudinal direction (back-and-forth direction) where the exerciser loses the balance easily. Therefore, the passive exercise machine can improve an accuracy of judging whether or not the exerciser is in the predetermined exercise position, thereby more improving its safety. FIG. 16 shows an example in which the two left foot load sensors 210 and 211 and the two right foot load sensors 220 and 221 are incorporated in the left-footrest 21 and the right-footrest 22, respectively. However, the number of the load sensors (such as, the left foot load sensors 210 and 211, and the right foot load sensors 220 and 221) is not limited to two, and may be three or more. In short, to provide at least two of the load sensors (such as, the left foot load sensors 210 and 211, and the right foot load sensors 220 and 221) to the resting surface P enables detecting the variation of the projected weight center of the exerciser in the longitudinal direction.

In the above embodiment, the router 32 of the drive unit 3 is configured to have the worm 320 and the worm wheels 321 for realizing the power transmission from the output shaft 310 of the motor 31 to the rotary shaft 35 of the worm wheel 321 with speed reduction. However, a belt can be utilized to transmit the power from the output shaft 310 of the motor 31 to the rotary shaft 35 perpendicular to the output shaft 310. In this instance, instead of the worm wheel 321, a pulley is utilized to receive the belt while dispensing with the worm 320.

In the above embodiment, the motor 31 has its output shaft 310 extending along the upper surface of the base plate 200. However, when the output shaft 310 is required to extend perpendicular to the upper surface of the base plate 200, spur gearing is adopted to achieve the transmission and routing of the rotary power, instead the combination of the worm 320 and the worm wheels 321. In this instance, pulleys and a belt may be used in place of the spur gearing for transmission of the rotary power between the pulleys.

Instead of using the crank plate 36 and the crank rod 38, the reciprocator 33 may be composed of a grooved cam driven to rotate by the motor 31 and a cam follower engaged in a groove of the cam. In this instance, the grooved cam can be used instead of the worm wheel 321 and be arranged to have its rotation axis parallel to the output shaft 310 of the motor 31 for power transmission from the output shaft 310 to the grooved cam through a pinion.

Further, when using only one grooved cam for power transmission from the output shaft 310 of the motor 31 to the groove cam, two cam followers can be used for engagement respectively with the cam grooves of the cams such that the grooved cam and the cam followers are cooperative to function as the router 32 as well as the reciprocators 33.

Although the illustrated embodiment has the base plate 200 formed with the guide surface 28 and the foot plate 23 formed with the follower projection 29, the same operation can be achieved with a configuration in which the foot plate 23 is provided with the guide surface 28 and the base plate 200 is provided with the follower projection 29.

Although, the passive exercise machine of the present embodiment is adapted in use to be placed on the floor, the passive exercise machine can be used with its portion embedded in the floor. A selection is made as to whether the passive exercise machine is placed at a fixed position or movably supported.

It is noted that, in the signal processor 18 of the present embodiment, the functions specific only to the control unit 180 and the judgment unit 183 of the present embodiment do not rely upon and are independent from the functions common or generic to the control unit 180, the calculation unit 181, and the judgment unit 183 shared by the present embodiment and the first embodiment. In short, the passive exercise machine of the present embodiment can perform one of the functions in the absence of the other function. The passive exercise machine of the present embodiment is defined as follows.

The passive exercise machine of the present embodiment includes the carrier provided with the left-footrest configured to bear the left foot of the exerciser, the right-footrest configured to bear a right foot of the exerciser, and the drive device configured to move the left-footrest and the right-footrest. The left-footrest and the right-footrest have the left foot load sensors and the right foot load sensors for detection of the partial load applied to the resting surface, respectively. The drive device includes the judgment unit configured to judge whether or not the exerciser is in the predetermined exercise position based on the partial loads detected by the each of the left foot load sensors and the right foot load sensors, and the control unit configured to control the drive device to stop moving the left-footrest and the right-footrest when the judgment unit judges the exerciser is not in the exercise position while the drive device moves the left-footrest and the light-footrest respectively.

### 3rd Embodiment

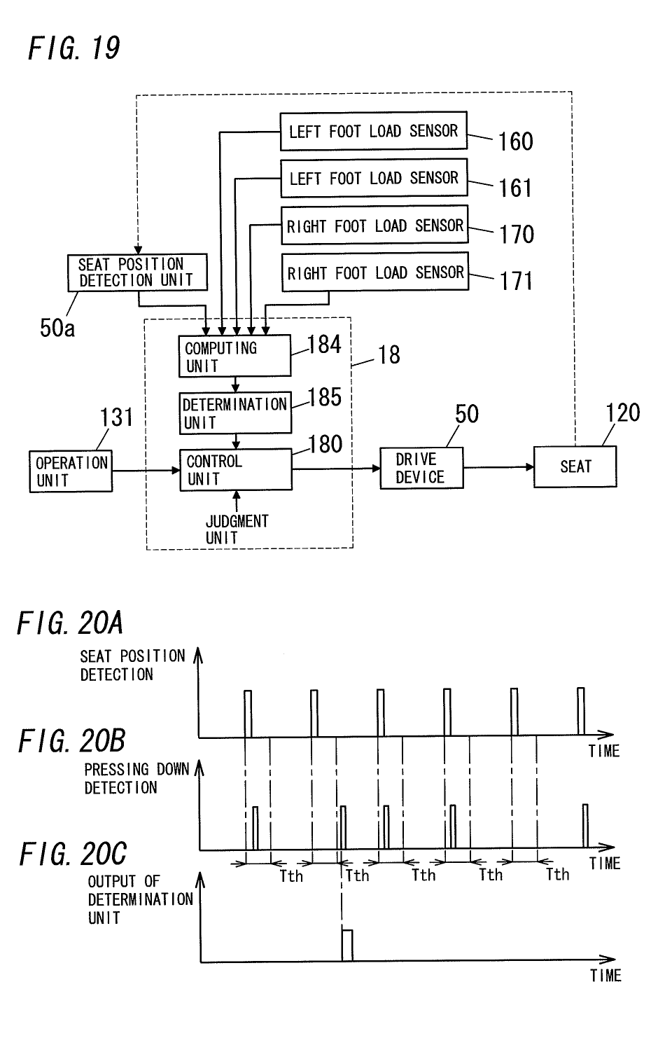

As shown in FIG. 19, a passive exercise machine in accordance with the present embodiment is different from the passive exercise machine of 1st embodiment in terms of inclusion of a seat position detector 50a configured to detect an event when the seat 120 moves to its forwardmost position within the moving range. The present embodiment and 1st embodiment have the same components which are attached the same reference number to, and an explanation concerning the same components is omitted.

The signal processor 18 of the present embodiment includes the control unit 180, the calculation unit 181, the storage unit 182, and the judgment unit 183, in a like fashion as the signal processor 18 of 1st embodiment (see FIG. 1) does. In addition, the signal processor 18 of the present embodiment includes a computing unit 184 and a determination unit 185. The computing unit 184 is configured to determine a necessary time which starts from detection of the event and ends at a time when the left foot load sensors 160 and 161 and the right foot load sensors 170 and 171 detect pressing down the left-footrest 14 and the right-footrest 15, respectively. The determination unit 185 is configured to judge whether or not the knee angle θ1 of the exerciser M is kept within the desired range based on the necessary time.

The seat position detection unit 50a includes at least a position sensor configured to detect that the seat 120 moves to its forwardmost position within the moving range. As shown in FIG. 20A, the seat position detection unit 50a outputs a position detection signal when detecting the event when the seat 120 moves to its forwardmost position within the moving range. Although the seat position detection unit 50a is housed in the drive device 50 in the present embodiment, the seat position detection unit 50a may be housed in the seat 120 to detect the position of the seat 120 directly. The seat position detection unit 50a may include a micro switch instead of the position sensor in order to detect that the seat 120 moves to its forwardmost position within the moving range.

The left foot load sensors 160 and 161 and the right foot load sensors 170 and 171 are placed under the left-footrest 14 and the right-footrest 15 together with springs 141 and 151, respectively. The left-footrest 14 is supported resiliently by a pair of the springs 141. One spring 141 supports the toe side of the left-footrest 14, and the other spring 141 supports the heel side of the left-footrest 14. The right-footrest 15 is supported resiliently by a pair of the springs 151. One spring 151 supports the toe side of the right-footrest 15, and the other spring 151 supports the heel side of the right-footrest 15. The left-footrest 14 and the right-footrest 15 move downward against bias of the springs 141 and 151 while the exerciser M treads the left-footrest 14 and the right-footrest 15, respectively. The left-footrest 14 and the right-footrest 15 return upward by the bias of the springs 141 and 151 while the exerciser M is not depressed the left-footrest 14 and the right-footrest 15, respectively. Thereby, a height position of the each of the left-footrest 14 and the right-footrest 15 relative to the floor is variable. The left foot load sensors 160 and 161 are placed corresponding to portions where the pair of the springs 141 supporting the left-footrest 14 is placed, respectively. Likewise, the right foot load sensors 170 and 171 are placed corresponding to portions where the pair of the springs 151 supporting the right-footrest 15 is placed, respectively. The left foot load sensors 160 and 161 judge that the exerciser M press down the left-footrest 14 with one's own foot when the height position of the foot resting surface 140 moves a threshold distance from an initial position where the left-footrest 14 is not depressed, as a result of the left-footrest 14 moving forward against the bias of the spring 141. And then, the left foot load sensors 160 and 161 output a depressing detection signal, as shown in FIG. 20C. Likewise, the right foot load sensors 170 and 171 judge that the exerciser M depresses the right-footrest 15 with one's own foot when the height position of the foot resting surface 150 moves a threshold distance from an initial position where the right-footrest 15 is not depressed, as a result of the right-footrest 15 moving forward against the bias of the spring 151. And then, the right foot load sensors 170 and 171 output the depressing detection signal, as shown in FIG. 20C.

Each of the left-footrest 14 and the right-footrest 15 is pressed down by the foot of the exerciser M because the exerciser's weight acting on the leg of the exerciser M is increased when the drive device 50 moves the seat 120 to the front most position. The necessary time (which starts from detection of the event and ends at a time when said left-footrest and said right-footrest detect the pressing down) is determined by the knee angle θ1, the height position of the bearing surface 121 of the seat 120 relative to the left-footrest 14 and the right-footrest 15 varied by the up-and-down device 60, and the moving range of the seat 120 determined by the drive device 50. In the present embodiment, the height position of the bearing surface 121 of the seat 120 and the moving range of the seat 120 are selected such that the necessary time is within a predetermined response time while the knee angle θ1 is kept within the desired range.

As described in the above, the seat position detection unit 50a outputs the position detection signal upon detecting the event when the seat 120 moves to its forwardmost position within the moving range. Each of the load sensors 160, 161, 170, and 171 outputs the depressing detection signal upon detecting the pressing down. Accordingly, the necessary time starts from a time of outputting the position detection signal, and ends at a time of outputting the depressing detection signal. As shown in FIG. 20C, the determination unit 185 judges that the knee angle θ1 of the exerciser M is kept within the desired range when the necessary time is not more than the predetermined response time Tth, and that the knee angle θ1 of the exerciser M is out of the desired range when the necessary time is more than the predetermined response time Tth. In the present embodiment, as shown in FIG. 20C, the determination unit 185 is configured to output an alert signal, upon judging that the knee angle θ1 of the exerciser M is not kept within the desired range.

In short, while the exerciser M makes a proper exercise where the knee angle θ1 of the exerciser M is kept within the desired range, the exerciser's weight acting on the leg of the exerciser M is increased as the seat 120 moves forward. In this instance, the depressing the left footrest 14 and the right-footrest 15 with the foot of the exerciser M is detected within the response time Tth from starting from a time when the seat 120 moves to its front most position, whereby the determination unit 185 determines that the knee angle θ1 of the exerciser M is kept within the desired range. On the other hand, when the exerciser M fails to make the proper exerciser with one's knee angle θ1 is kept within the desired range for reason of that the height position of the seat 120 is not commensurate with the exerciser's physique or the exerciser is insufficient in pressing down the footrest, there arises a delay in pressing down the footrest sufficiently with the exerciser's foot. In this consequence, no detection of pressing down the footrests 14 and 15 is made within the response time Tth starting from a time when the seat 120 moves to its front most position, whereby the determination unit 185 determines that the knee angle θ1 of the exerciser M has not been not kept within the desired range.

Although the determination unit 185 judges that the knee angle θ1 of the exerciser M is out of the desired range only when the necessary time exceeds the predetermined response time Tth in the present embodiment, the determination unit 185 may judge that the knee angle θ1 of the exerciser M is out of the desired range, when the necessary time exceeds the predetermined response time Tth, or when the depressing detection signal is not output within the predetermined response time Tth. In the former case, the determination unit 185 is configured to output the alert signal when the depressing detection signal is output after the response time Tth elapses. In the latter case, the determination unit 185 is configured to output the alert signal when the response time Tth elapses until the depressing detection signal is output.

The determination unit 185 transmits the above mentioned alert signal to the control unit 180. The control unit 180 executes a slow stop control to stop moving the seat 120 when the number of times the control unit 180 receives the alert signal from the determination unit 185 becomes equal to a predetermined number of times. In the slow stop control, the control unit 180 controls the drive device 50 such that the drive device 50 decreases a rotation speed of the motor 71 to slow down the seat 120 and finally stops the motor 71 as well as the seat 120. The control unit 180 resets at the regular intervals (for example, 1 minute) the number of times the control unit 180 receives the alert signal from the determination unit 185. That is, the control unit 180 stops the seat 120 when the number of times the control unit 180 receives the alert signal for 1 minute exceeds the predetermined number of times. The control unit 180 may reset the number of times the control unit 180 receives the alert signal when the seat 120 is stopped. That is, the control unit 180 may start to count the number of times the control unit 180 receives the alert signal after the seat 120 starts to move, and subsequently control the drive device 50 to stop the seat 120 when the counted number of times exceeds the predetermined number of times.

According to the present embodiment, the determination unit 185 can judge whether or not the knee angle θ1 of the exerciser M is kept within the desired range, and the seat 120 is slowed down and finally stopped when the number of times the determination unit 185 judges that the knee angle θ1 of the exerciser M is out of the desired range becomes equal to the predetermined number of times. Therefore, concerning the exerciser M who keeps own knee angle θ1 within the desired range, the passive exercise machine can allow the exerciser M to continue to the passive exercise. Meanwhile, concerning the exerciser M who fails to keep own knee angle θ1 within the desired range, the passive exercise machine can instruct the exerciser M to make the proper exercise where the knee angle θ1 of the exerciser M is kept within the desired range, thereby being able to give a preferable exercise effect to the exerciser M.

In addition, the control unit 180 controls the drive device 50 to stop the seat 120 when the exerciser M fails to keep own knee angle θ1 within the desired range. Accordingly, for example, the passive exercise machine can avoid that the exerciser M suffering from knee pains is burdened continuously. Further, the control 180 executes the slow stop control concerning the seat 120. Accordingly, the passive exercise machine can avoid that the exerciser M is dropped off the seat 120 when the seat 120 is stopped. The seat 120 is kept moving until the number of times the determination unit 185 judges that the knee angle θ1 of the exerciser M is out of the desired range becomes equal to the predetermined number of times. Accordingly, even if the exerciser M fails to press down the footrests 14 and 15 only once while continuing to make the proper exercise with one's knee angle θ1 kept within the desired range, the passive exercise machine keeps the seat 120 moving and allows the exerciser to continue making the proper exercise.

In making the exercise with the passive exercise machine of the present embodiment, an experimental result confirmed that improvement of the exercise effect with less knee pain is obtained when the knee angle θ1 (angle between the femoral region and a leg region at a front side of the knee in actual measurement) is set to be 140°. In view of this experimental result, the above mentioned desired range is selected to be a range centered at 140°. Further, it is assumed that the response time Tth is selected to be 0.1 seconds and the predetermined number of times is selected to be 10.

By the way, although the present embodiment exemplifies the passive exercise machine in which the determination unit 185 sends a result (judgment result) of the determination unit 185 to the control unit 180 and the seat 120 is slowed and finally stopped when the determination unit 185 judges that the knee angle θ1 of the exerciser M is out of the desired range, the passive exercise machine of the present embodiment is not limited to the above configuration. The passive exercise machine of the present embodiment may include a means (report unit) configured to report to the exerciser M the result of the determination unit 185 indicating whether or not the knee angle of the exerciser M is kept within the desired range. For example, the report unit includes at least one of a display unit displaying the result and a speaker (audio output unit) producing a sound indicative of the result.

In addition, the passive exercise machine of the present embodiment may include the handle post upstanding from the platform 11 and having its upper end the handles which are adapted in use to be held with hands of the exerciser M as necessary, and the operation unit 131 attached to the handle post. However, the exerciser's weight acting on the handles is required to be limited by a position of the handles and the like such that the exerciser M presses down on the footrests 14 and 15 within the predetermined response time starting from the time at which the seat 120 moves to the front most position while the knee angle θ1 of the exerciser M who holds the handles is kept within the desired range.

It is noted that, in the signal processor 18 of the present embodiment, the functions specific only to the control unit 180 and the determination unit 185 of the present embodiment do not rely upon and are independent from the functions common or generic to the control unit 180, the calculation unit 181, and the judgment unit 183 shared by the present embodiment and the first embodiment. In short, the passive exercise machine of the present embodiment can perform one of the functions in the absence of the other function. The passive exercise machine of the present embodiment is defined as follows.

The passive exercise machine of the present embodiment is characterized by the seat, the footrest, the drive device, the seat position detection unit, the left foot load sensor, the right foot load sensor, and the determination unit. The seat is configured to swing with associated movements in back-and-forth direction, and configured to bear the buttocks of the exerciser. The footrest is configured to bear the foot of exerciser who sits on the seat. The footrest is configured to move downward while the exerciser presses down the footrest by one's foot and to return upward while the exerciser releases the footrest. The drive device is configured to move the seat to its forwardmost position within the moving range to force the exerciser to make pressing down the footrest, thereby varying the exerciser's weight acting on the leg of the exerciser. The seat position detection unit is configured to detect the event when the seat moves to its forwardmost position within the moving range. The left foot load sensor is configured to detect that the exerciser presses down the left-footrest by exerciser's left foot. The right foot load sensor is configured to detect that the exerciser presses down the right-footrest by exerciser's right foot. The determination unit is configured to judge that the knee angle of the exerciser is kept within the desired range when the necessary time is not more than the predetermined response time, and that the knee angle is out of the desired range when the necessary time exceeds the predetermined response time.

Each of the embodiments described in the present description shows only an example of the present invention, and gives no limitation about the scope of the present invention. The scope of the invention includes various changes and modifications made on the basis of claims or descriptions of the present invention.

1. A passive exercise machine adapted in use to induce muscle activity of an exerciser, said passive exercise machine comprising:
a left-footrest configured to bear a left foot of the exerciser;
a right-footrest configured to bear a right foot of the exerciser;
a drive device configured to move a body of the exerciser to vary a load applied to said left-footrest by the left foot and a load applied to said right-footrest by the right foot;
a plurality of left foot load sensors incorporated in different portions of said left-footrest to detect partial loads applied to said respective left foot load sensors, said different portions of said left-footrest being arranged in a longitudinal direction of said left-footrest;
a plurality of right foot load sensors incorporated in different portions of said right-footrest to detect partial loads applied to said respective right foot load sensors, said different portions of said right-footrest being arranged in a longitudinal direction of said right-footrest;
a calculation unit configured to calculate a center point of the load applied to said left-footrest on the basis of the partial loads detected by said left foot load sensors and a center point of the load applied to said right-footrest on the basis of the partial loads detected by said right foot load sensors;
a storage unit configured to store an ideal characteristic curve indicative of ideal time variation of both the center point of the load applied to said left-footrest and the center point of the load applied to said right-footrest;
a judgment unit configured to judge at regular intervals whether or not a deviation between each of the center points calculated by said calculation unit and the center point indicated by said ideal characteristic curve is not less than a predetermined threshold; and
a control unit configured to count the number of times the deviation is not less than the predetermined threshold, said control unit being configured to, when the counted number of times is not less than a predetermined number during a predetermined time longer than the regular interval, control said drive device to decrease a speed at which said drive device moves the body of the exerciser.

2. A passive exercise machine as set forth in claim 1, wherein
said control unit is configured to, when the counted number of times is not less than the predetermined number during the predetermined time, control said drive device to decrease the speed gradually, and finally to stop moving the body of the exerciser.

3. A passive exercise machine as set forth in claim 1, wherein
said passive exercise machine comprises a seat which bears buttocks of the exerciser with one's feet resting respectively on said left-footrest and said right-footrest on its bearing surface, and
said drive device being configured to move said seat from an initial position in order to vary the center point of the load applied to said left-footrest and the center point of the load applied to said right-footrest.

4. A passive exercise machine as set forth in claim 1, wherein
said drive device is configured to alternately repeat a mode of moving said left-footrest forward and raising the front end relative to the rear end thereof, while moving said right-footrest to lower the front end relative to the rear end thereof, and another mode of moving said right-footrest forward and raising the front end relative to the rear end thereof, while moving said left-footrest to lower the front end relative to the rear end thereof.

5. A passive exercise machine as set forth in claim 1, wherein
said control unit is configured to count the number of times after controlling said drive device to decrease the speed, said control unit being configured to, when the counted number of times is kept less than the predetermined number for a certain period during the predetermined time, control said drive device to increase the speed.

6. A passive exercise machine as set forth in claim 1, wherein
said drive device is configured to move said left-footrest and said light-footrest respectively,
said judgment unit being configured to judge whether or not the exerciser is in a predetermined exercise position, on the basis of the partial loads detected by each of said left foot load sensors and each of said right foot load sensors, and
said control unit being configured to, when said judgment unit judges the exerciser is not in the exercise position while said drive device moves said left-footrest and said light-footrest respectively, control said drive device to stop moving said left-footrest and said right-footrest.

7. A passive exercise machine as set forth in claim 6, wherein
said judgment unit is configured to calculate a projected weight center of the exerciser based on respective locations of said left foot load sensor and said right foot load sensor, as well as the partial loads respectively detected at said left foot load sensor and said right foot load sensor, said projected weight center being defined as a point to which the weight center of the exerciser projects vertically down on a horizontal plane in which said left foot load sensor and said right foot load sensor are arranged, and
said judgment unit being configured to judge that the exerciser is out of the predetermined exercise position when the projected weight center deviates from a prescribed range in the horizontal plane.

8. A passive exercise machine as set forth in claim 1, wherein
said passive exercise machine comprises:
a seat configured to swing with associated movements in back-and-forth direction, said seat being configured to bear buttocks of the exerciser;
a footrest configured to function as said left-footrest or said right-footrest, said footrest being configured to bear the foot of exerciser who sits on said seat, and said footrest being configured to move downward while the exerciser presses down said footrest by one's foot and to return upward while the exerciser releases said footrest;
a device configured to function as said drive device, said device being configured to move said seat to its forwardmost position within a moving range to force the exerciser to make pressing down said footrest, thereby varying a load applied to a leg of exerciser by own weight;
a seat position detection unit configured to detect an event when the seat moves to its forwardmost position within the moving range; and
a determination unit configured to judge that a knee angle of the exerciser is kept within a desired range when a necessary time is not more than a predetermined response time, and that the knee angle is out of the desired range when the necessary time is more than the predetermined response time, the necessary time starting from detection of the event and ending at a time when the left foot load sensor and the right foot load sensor detect the pressing down.

9. A passive exercise machine as set forth in claim 8, wherein
said control unit is configured to, when the number of times said determination unit judges the knee angle is out of the predetermined range becomes equal to a predetermined number of times, control said drive device to slow down a movement of said seat gradually, and finally to stop said seat.

10. A passive exercise machine as set forth in claim 8, wherein
said passive exercise machine comprises a report unit configured to report a result of said determination unit to the exerciser, the report unit including at least one of a display unit displaying the result and an audio output unit producing a sound indicative of the result.

11. A passive exercise machine as set forth in claim 2, wherein
said passive exercise machine comprises a seat which bears buttocks of the exerciser with one's feet resting respectively on said left-footrest and said right-footrest on its bearing surface, and
said drive device being configured to move said seat from an initial position in order to vary the center point of the load applied to said left-footrest and the center point of the load applied to said right-footrest.

12. A passive exercise machine as set forth in claim 2, wherein
said drive device is configured to alternately repeat a mode of moving said left-footrest forward and raising the front end relative to the rear end thereof, while moving said right-footrest to lower the front end relative to the rear end thereof, and another mode of moving said right-footrest forward and raising the front end relative to the rear end thereof, while moving said left-footrest to lower the front end relative to the rear end thereof.

13. A passive exercise machine as set forth in claim 9, wherein
said passive exercise machine comprises a report unit configured to report a result of said determination unit to the exerciser, the report unit including at least one of a display unit displaying the result and an audio output unit producing a sound indicative of the result.
